(19) United States
(12) Patent Application Publication
(10) Pub. No.: US 2025/0271867 A1
(43) Pub. Date: Aug. 28, 2025

(54) SYSTEM AND METHOD FOR PLANNING OPERATIONS OF LARGE-SCALE AUTONOMOUS VEHICLE FLEET

(71) Applicant: Symbotic LLC, Wilmington, MA (US)

(72) Inventors: Jingkai CHEN, Wilmington, MA (US); Kirill PANKRATOV, Acton, MA (US)

(21) Appl. No.: 19/064,162

(22) Filed: Feb. 26, 2025

Related U.S. Application Data
(60) Provisional application No. 63/558,415, filed on Feb. 27, 2024.

(51) Int. Cl. G05D 1/644; B65G 1/04; G05D 1/69; G05D 105/28

(52) U.S. Cl. CPC G05D 1/644; B65G 1/0492; G05D 1/69; G05D 2105/28

(57) ABSTRACT

An automated storage and retrieval system includes a storage array, a plurality of autonomous guided bots, and a controller connected to each autonomous guided bot to assign a series of tasks to each autonomous guided bot, which series of tasks includes a task to an autonomous guided bot moving the autonomous guided bot from initial location to a different final location via bot routes. The controller is configured with a bot route planner that has a resolver that seeks conflicts between autonomous guided bots on the bot routes describing bot paths, and resolves each bot route to determine the bot route, at least one bot route being determined based on bot priority, and the resolver sequences the bot routes into a sequence of bot route leg batches, where route legs, forming each bot route in entirety, are divided into corresponding batch of the sequence of route leg batches.

### CROSS-REFERENCE TO RELATED APPLICATIONS

This application is a non-provisional of, and claims the benefit of, U.S. provisional patent application No. 63/558,415 filed on Feb. 27, 2024, the disclosure of which is incorporated herein by reference in its entirety.

### BACKGROUND

### 1. Field

The exemplary embodiments generally relate to material handling systems, and more particularly, to transport of items within the material handling system.

### 2. Brief Description of Related Developments

Generally multi-agent pathfinding is employed in automated systems, such as logistics facilities and warehouses, to determine collision-free paths for groups of autonomous transport vehicles (i.e., agents) that transport items within the automated system. One example of multi-agent pathfinding is the prioritized planning(PP) technique where fixed priorities of planning goals are found and then plans for the autonomous transport vehicles are generated given these priorities. Another example, of multi-agent pathfinding is the priority-based search (PBS) technique, which does not assume a fixed priority. Rather, priority-based search specifies priorities only on demand. An extension of priority-based search, referred to as the priority-based search with precedence constraint (PBS-PC) technique, may be employed to handle cases where each autonomous transport vehicle has a sequence of goals (i.e., route legs). In the priority-based search techniques (PBS and PBS-PC), the priorities are specified automatically and systematically to resolve planning conflicts and optimize routing performance. However, the priority-based search techniques are centralized multi-agent processes having runtimes that are dominated by the number of conflicts between agents to resolve. In practice, the runtime of the process increases cubically as the number of conflicts to resolve increases. In practice, the number of conflicts to resolve can rapidly increase when the number of tasked autonomous transport vehicles increases or autonomous transport vehicle traffic within the automated system becomes severe (i.e., several autonomous transport vehicles are tasked to travel to or within a common/same region of the logistics facility or warehouse).

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is an exemplary block diagram of an automated storage and retrieval system incorporating aspects of the present disclosure;

FIG. 1A is an exemplary schematic illustration of a portion of the automated storage and retrieval system of FIG. 1 in accordance with the present disclosure;

FIG. 1B is an exemplary schematic illustration of a portion of the automated storage and retrieval system of FIG. 1 in accordance with the present disclosure;

FIG. 1C is an exemplary schematic illustration of a portion of the automated storage and retrieval system of FIG. 1 in accordance with the present disclosure;

FIG. 1D is an exemplary schematic illustration of a goods processed by the automated storage and retrieval system of FIG. 1 in accordance with the present disclosure;

FIG. 2A is an exemplary schematic illustration of a portion of the automated storage and retrieval system of FIG. 1 in accordance with the present disclosure;

FIG. 2B is an exemplary schematic illustration of a portion of the automated storage and retrieval system of FIG. 1 in accordance with the present disclosure;

FIG. 2C is an exemplary schematic illustration of a portion of the automated storage and retrieval system of FIG. 1 in accordance with the present disclosure;

FIG. 2D is an exemplary schematic illustration of a portion of the automated storage and retrieval system of FIG. 1 in accordance with the present disclosure;

FIG. 3 is an exemplary schematic illustration of an autonomous guided bot of the automated storage and retrieval system of FIG. 1 in accordance with the present disclosure;

FIG. 4 is an exemplary schematic illustration of a portion of the automated storage and retrieval system of FIG. 1 in accordance with the present disclosure;

FIG. 4A is an exemplary schematic illustration of portions of trajectories of an autonomous guided bot of the automated storage and retrieval system of FIG. 1 in accordance with the present disclosure;

FIG. 5A illustrates convention autonomous guided bot routes;

FIG. 5B illustrates autonomous guided bot routes of the automated storage and retrieval system of FIG. 1 in accordance with the present disclosure;

FIG. 6A is an exemplary schematic illustration of autonomous guided bot route legs of an autonomous guided bot of the automated storage and retrieval system of FIG. 1 in accordance with the present disclosure;

FIG. 6B is an exemplary schematic illustration of autonomous guided bot route legs for autonomous guided bots of the automated storage and retrieval system of FIG. 1 in accordance with the present disclosure;

FIG. 7 is an exemplary autonomous guided bot route leg threat graph for route legs of autonomous guided bots of the automated storage and retrieval system of FIG. 1 in accordance with the present disclosure;

FIG. 8 is an exemplary threat relation chart in accordance with the present disclosure; and

FIGS. 9, 10, and 11 are exemplary flow diagrams of methods in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

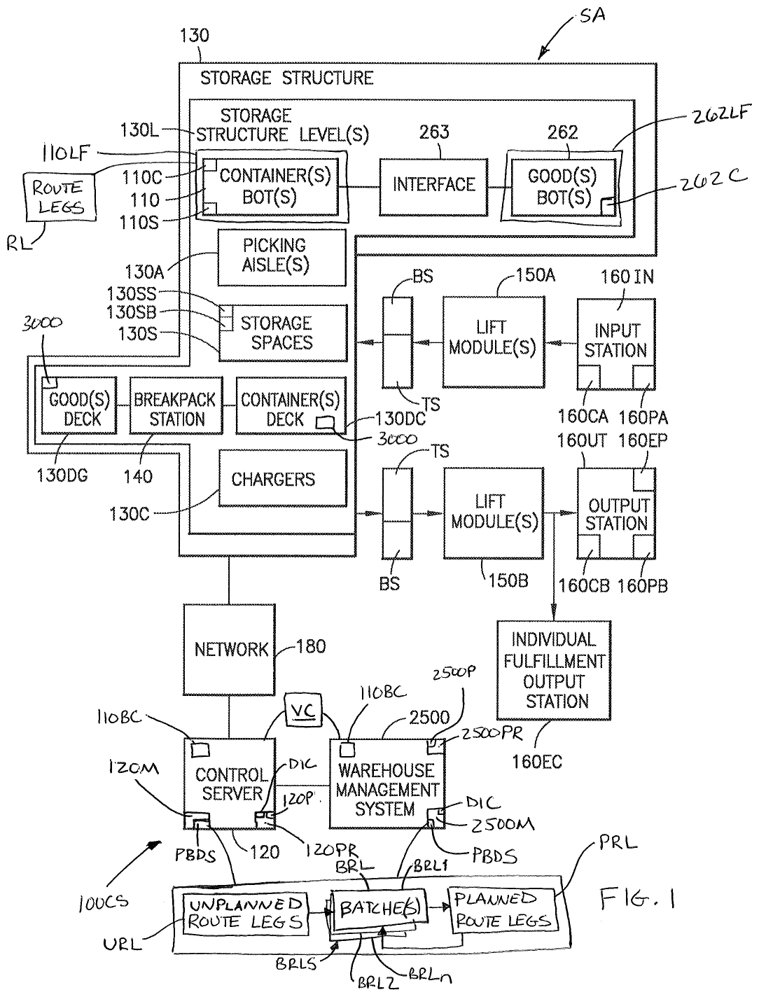

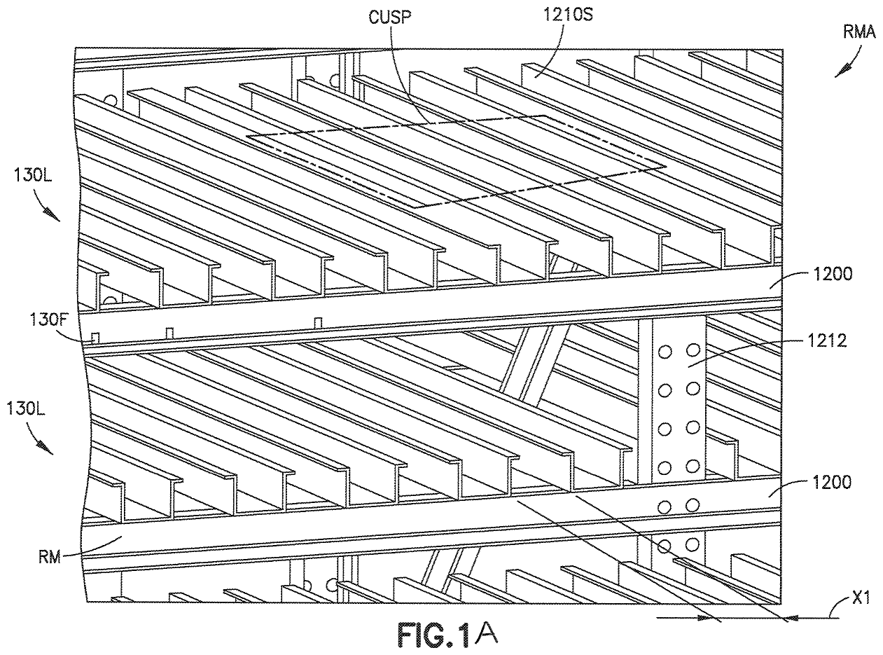

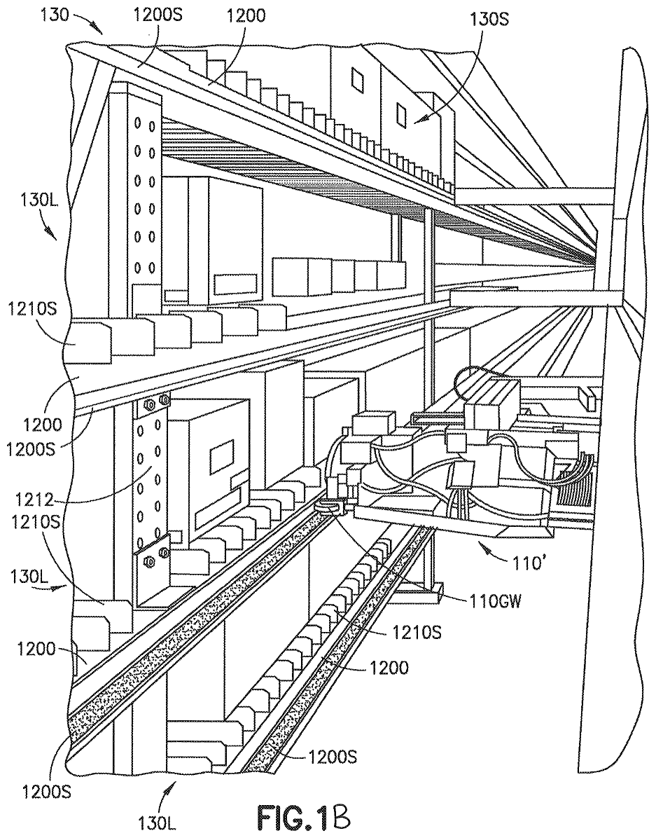

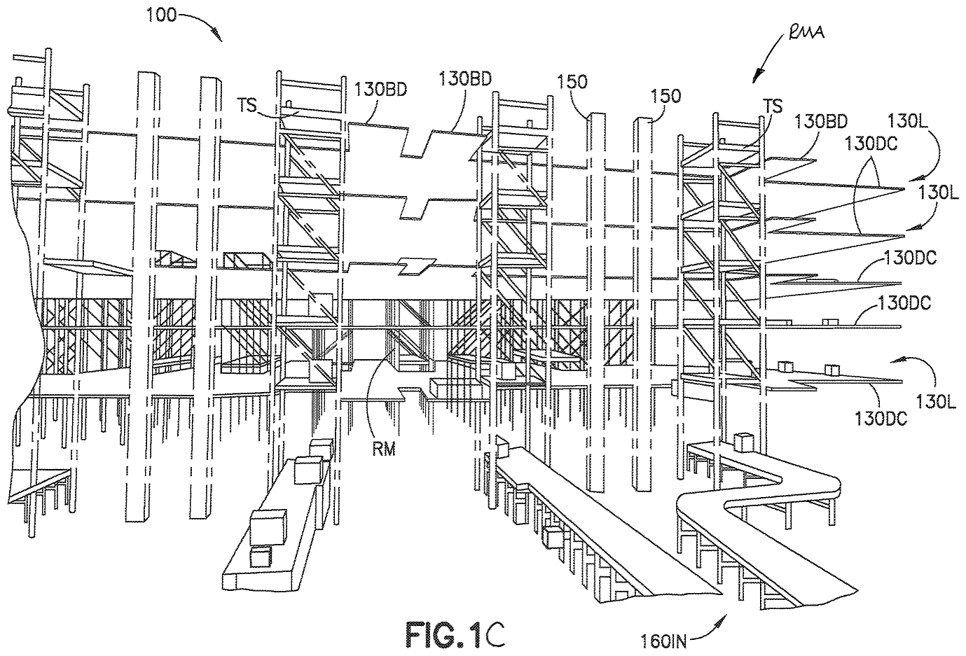

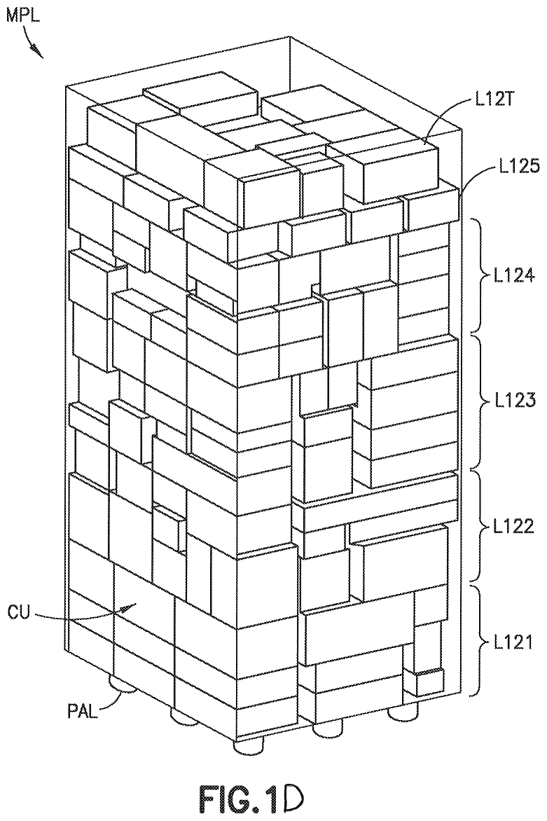

FIG. 1 illustrates an exemplary automated storage and retrieval system 100, such as of a logistics facility or warehouse, in accordance with aspects of the present disclosure. Although the aspects of the present disclosure will be described with reference to the drawings, it should be understood that the aspects of the present disclosure can be embodied in many forms. In addition, any suitable size, shape or type of elements or materials could be used.

The present disclosure provides for the automated storage and retrieval system 100 including a storage array SA with storage locations 130S arrayed along aisles 130A and a static (i.e., non-moving) non-deterministic transfer deck 130DC communicating with each aisles 130A. The storage array SA includes one or more of the storage array features described herein.

As also described herein, the storage locations may form breakpack goods interface locations 263L disposed along aisles formed on or in communication with a static (i.e., non-moving) non-deterministic (goods) transfer deck 130DG. The storage locations formed by the breakpack goods interface locations 263L may form a part of the storage array SA or be considered another storage array BSA (with respect to path planning of autonomous guided goods bots 262) of the automated storage and retrieval system 100 to which the present disclosure is applied independent of path planning of autonomous guided container bots 110. Path planning of the autonomous guided goods bots 262 and autonomous guided container bots 110 may be performed in conjunction with each other.

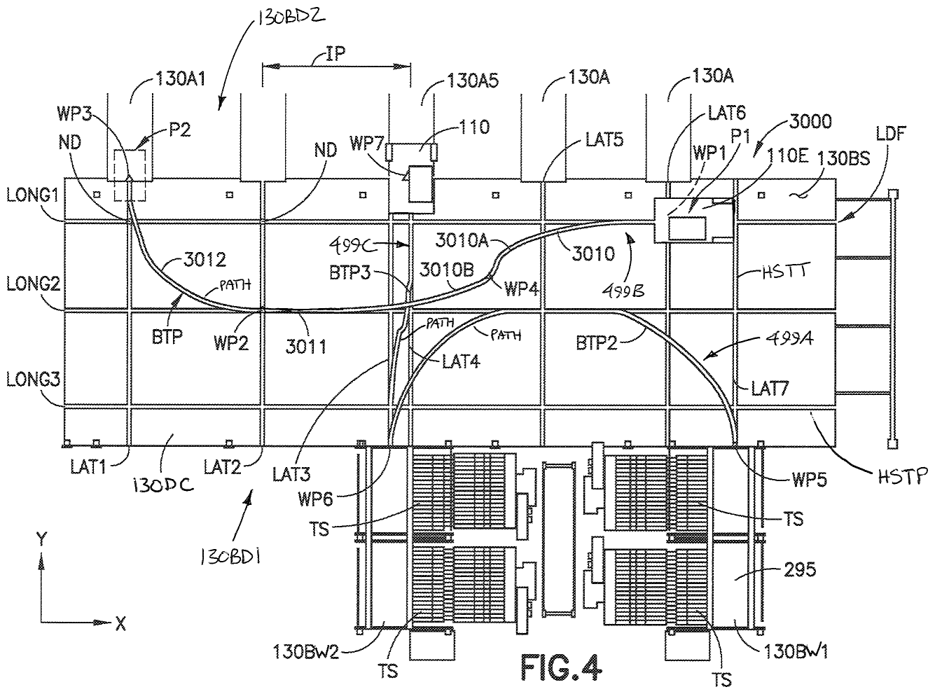

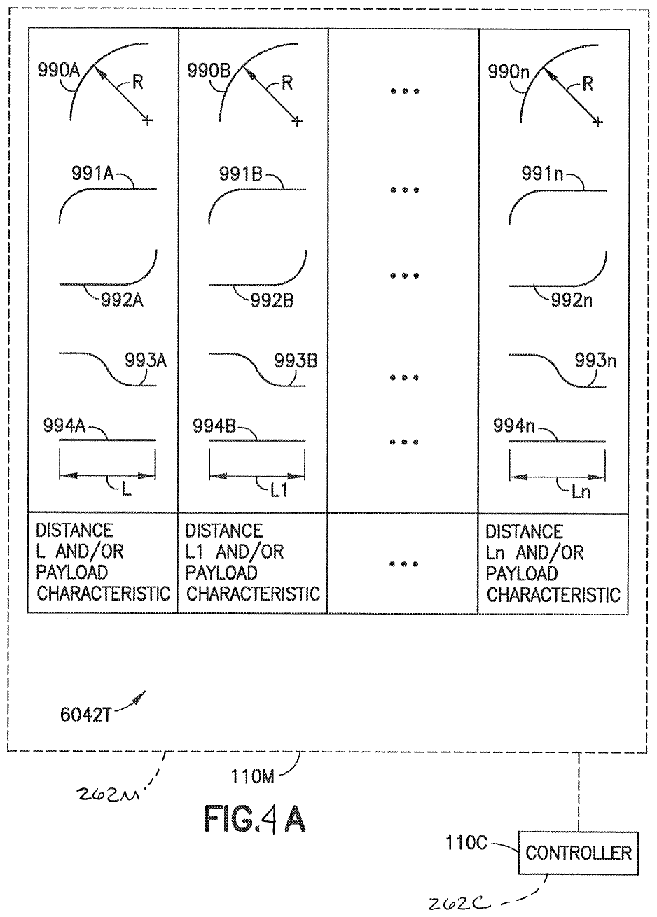

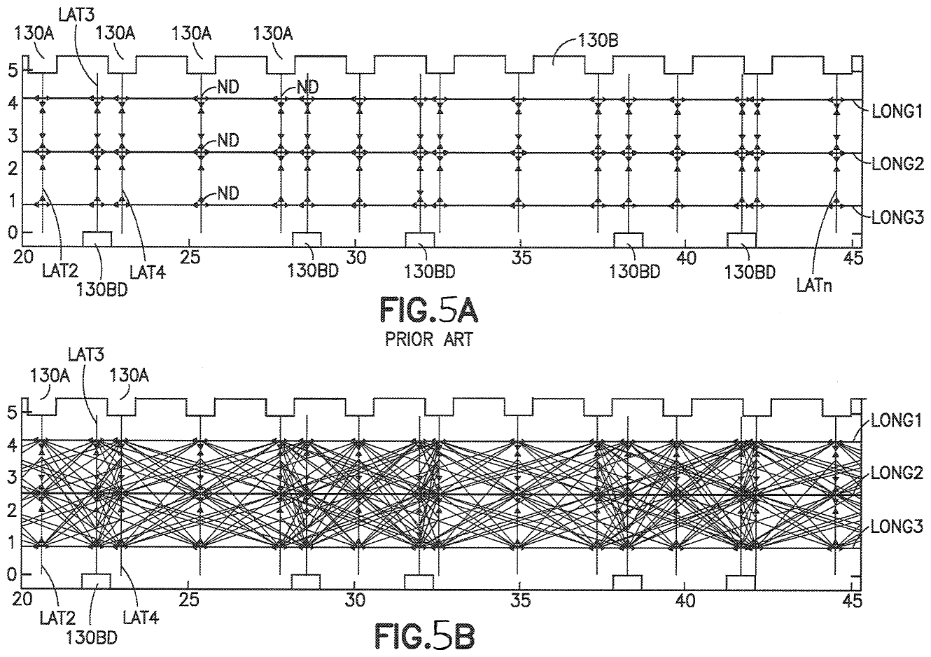

The automated storage and retrieval system 100 includes a plurality of autonomous guided bots or vehicles (e.g., one or more of a plurality of autonomous guided container bots 110 and a plurality of autonomous guided goods bots 262), each configured for free ranging motion so as to traverse freely along bot paths (e.g., BPT-BPT3, see FIGS. 4 and 5B, as described herein). The bot paths including one or more of time optimal paths, unparameterized paths, and time optimal unparameterized paths, on the non-deterministic deck (e.g., a respective one or more of the container transport deck 130DC and the breakpack goods deck 130DG).

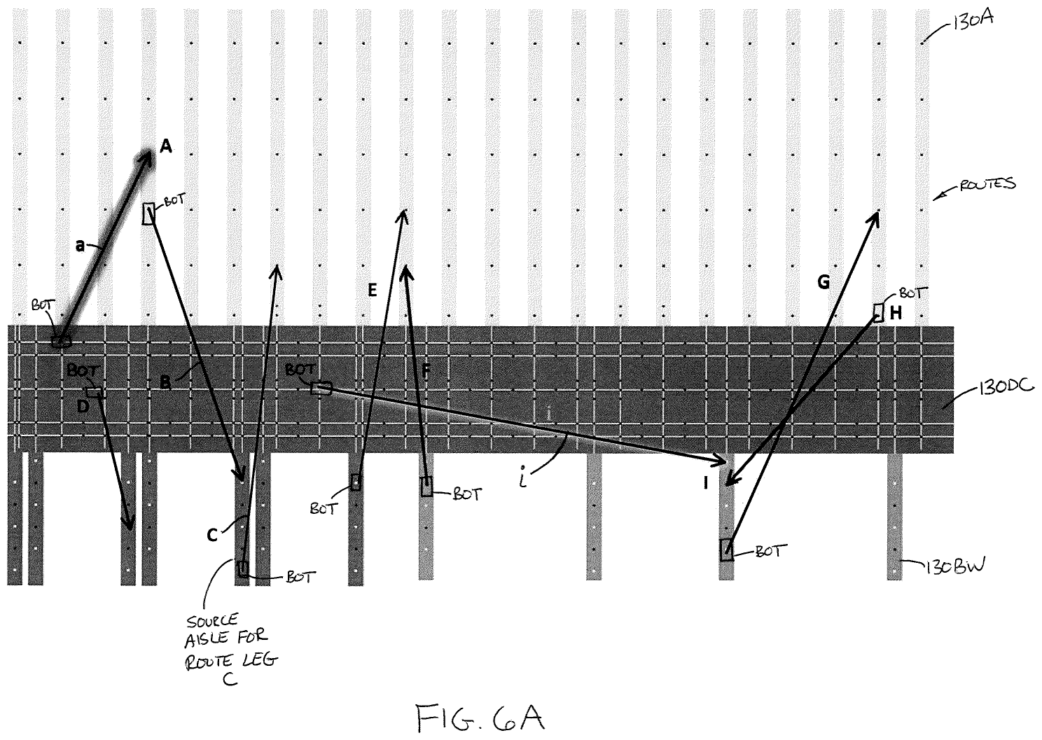

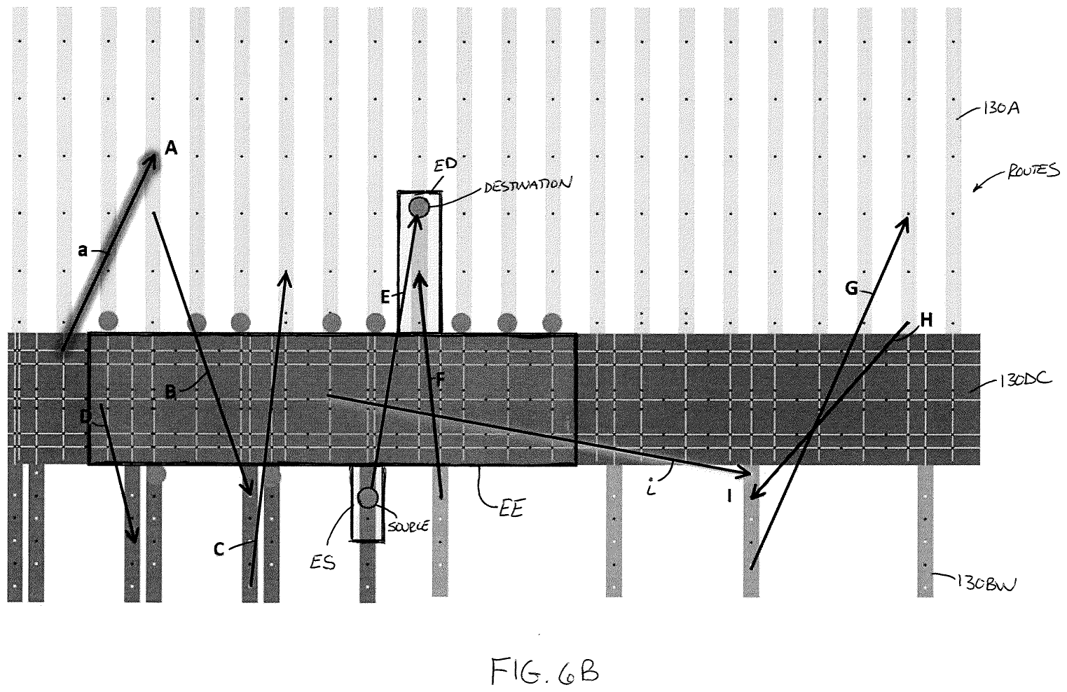

The automated storage and retrieval system 100 includes a controller (such as one or more of control server 120 and warehouse management system 2500 or other suitable controller) that is communicably connected to each autonomous guided bot of the plurality of autonomous guided bots (e.g., one or more of the plurality of autonomous guided container bots 110 and autonomous guided goods bots 262) so as to assign a series of tasks to each autonomous guided bot. The series of tasks includes at least one task to at least one autonomous guided bot 110, 262 moving the autonomous guided bot 110, 262 from an initial location to a different final location via bot routes 499A-499C (see FIGS. 4, 6A and 6B).

Each of the bot routes 499A-499C may be determined batch by batch in the manner described herein.

The series of the series of tasks include a current task, and at least one of a preceding task (preceding the current task in series) and a following task (following the current task in series). The at least one task is the current, the preceding task, or the following task.

The controller is configured with a bot route planner 120P, 2500P that has a resolver 120PR, 2500PR that seeks (or otherwise determines) conflicts between autonomous guided bots, effecting the series of tasks, on bot routes 499A-499C describing both paths (see FIGS. 4, 6A, and 6B). The resolver 120PR, 2500PR resolves each bot route so as to determine the bot route, where at least one bot route is determined based on bot priority. The resolver 120PR, 2500PR is arranged to sequence the bot routes into a sequence of bot route legs batches BRL, wherein route legs (as described herein, and illustrated in the Figures as Manhattan distances, which is a metric in which the distance between two points is the sum of the absolute differences in their Cartesian coordinates), forming each bot route in entirety, are divided into corresponding batch of the sequence of route leg batches BRL. It is noted that an autonomous guided bot belonging to a route leg need not be in motion such that a route leg may denote one or more of a traverse path, an initial pose of the autonomous guided bot, and a destination pose of the autonomous guided bot.

As described herein: the bot route leg batches BRL are prioritized in sequence BRLS, and an earlier or preceding batch in the sequence has a higher priority to a later or subsequent batch in the sequence; at least one bot route leg, in the sequence of bot route legs describing a bot route, is deferred to a later bot route leg batch in the sequence of bot route leg batches; the later bot route leg batch, that includes the deferred at least one bot route leg, is disposed in a later place in the sequence BRLS of bot route leg batches BRL than the at least one bot route leg in sequence of the bot route legs describing the bot route 499A-499C; and/or the deferred at least one bot route leg has a lower priority than undeferred bot route legs.

The present disclosure provides for, with the controller (e.g., such as one or more of controller 120 and warehouse management system 2500 including the respective resolver 120PR, 2500PR, which in some aspects forms part of a control system 100CS), autonomous transport vehicle travel path planning in the automated storage and retrieval system 100 having one or more large fleet 110LF, 262LF of autonomous guided bots (such as autonomous guided container transport vehicles or container bots 110 and/or autonomous goods transport vehicles or autonomous guided goods bots 262 which are collectively and generally referred to herein as autonomous guided bots 110, 262).

Each large fleet 110LF, 262LF of autonomous guided bots 110, 262 includes about three hundred autonomous guided bots 110, 262, up to about three hundred autonomous guided bots 110, 262, between about twenty autonomous guided bots 110, 262 and about three hundred autonomous guided bots 110, 262, between about twenty autonomous guided bots 110, 262 and about three hundred autonomous guided bots 110, 262, between about forty autonomous guided bots 110, 262 and about three hundred autonomous guided bots 110, 262, between about one hundred autonomous guided bots 110, 262 and about three hundred autonomous guided bots 110, 262, and between about two hundred autonomous guided bots 110, 262 and about three hundred autonomous guided bots 110, 262. While the present disclosure is described herein with respect to non-holonomic autonomous guided bots 110, 262 (as described herein), the present disclosure is equally applicable with respect to holonomic autonomous transport vehicles or bots such as those produced by Boston Dynamics Inc. of Waltham, Massachusetts (United States) (see, e.g., U.S. Pat. No. 10,265,871 issued on Apr. 23, 2019 and U.S. patent application Ser. No. 17/699,534 filed on Mar. 21, 2022); and those produced by Amazon Technologies Inc. (see, e.g., U.S. Pat. No. 11,643,279 issued on May 9, 2023).

The automated storage and retrieval system 100 has a control system 100CS that includes one or more of the control server 120 (also referred to as a controller) and the warehouse management system 2500. The control system 100CS is configured (i.e., the one or more of the control server 120 and warehouse management system 2500 has the respective resolver 120PR, 2500PR configured) with non-transitory computer program code that embodies a priority-based divide and search autonomous transport vehicle path planning process PBDS (also referred to as a single bot planner) as described herein. The priority-based divide and search autonomous transport vehicle path planning process PBDS is resident in a memory of the control system 100CS, such as one or more of memory 120M of control server 120 and memory 2500M of the warehouse management system 2500. When the priority-based divide and search autonomous transport vehicle path planning process PBDS is executed by a processor (such as one or more of bot route planner 120P of control server 120 and bot route planner 2500P of the warehouse management system 2500) of the control system 100CS, the priority-based divide and search autonomous transport vehicle path planning process PBDS causes one or more autonomous transport vehicles 110, 262 of the automated storage and retrieval system 100 to operate as described herein.

The priority-based divide and search autonomous transport vehicle path planning process PBDS configures the controller, such as one or more of control server 120 and warehouse management system 2500, of the automated storage and retrieval system 1000 so that the control controller plans travel paths (which as described herein may be straight paths, arcuate paths, compound paths forming shapes such as “S” shape curves, or any other combination of straight and arcuate paths) of the autonomous transport vehicles 110, 262 of the respective large fleet 110LF, 262LF within several hundred milliseconds, and particularly within about three hundred milliseconds and less than about five hundred milliseconds, and more particularly less than about 100 milliseconds. The autonomous transport vehicles 110, 262 of each large fleet 110LF, 262LF may be isolated from each other so that each large fleet 110LF, 262LF is separate and distinct from each other large fleet 110LF, 262LF. The large fleets 110LF, 262LF operate in separate and distinct areas of the automated storage and retrieval system 100 such that the paths and trajectories of route legs for autonomous container transport vehicles 110 of large fleet 110LF do not interfere with the paths and trajectories of route legs of the autonomous goods transport vehicles 262 of large fleet 262LF. Path planning as described herein may be performed for each one of large fleet 110LF, 262LF independent of path planning for each other large fleet 110LF, 262LF.

The controller, configured with the priority-based divide and search autonomous transport vehicle path planning process PBDS, divides all route legs RL (e.g., route legs are one or more portions of respective travel paths of respective autonomous transport vehicles 110, 262 or the respective large fleet 110LF, 262LF) of a respective large fleet 110LF, 262LF that are to be planned into a sequence BRLS of route leg batches BRL1-BRLn (generally referred to herein as “batches BRL”), and plans (e.g., the trajectories and paths of) the route legs RL batch by batch. Dividing all of the route legs RL into batches BRL provides for analysis of a smaller number of route legs RL compared to analysis of all of the route legs RL together, which provides for a fewer number of conflicts (such as for large fleet 110LF collisions between autonomous transport vehicles 110 and for large fleet 262LF collisions between autonomous transport vehicles 262) to resolve in each batch BRL, such that the route legs RL are planned in fewer iterations than if all of the route legs RL were planned together. The sequence BRLS of batch legs BRL prioritizes the batch legs BRL relative to each other from a highest priority to a lowest priority as described herein.

As will be described in greater detail herein, and with reference to FIG. 1, for each large fleet 110LF, 262LF, the priority-based divide and search autonomous transport vehicle path planning process PBDS of the controller is configured to obtain or otherwise collect unplanned route legs URL from any suitable source such as from one or more vehicle controller VC, where the one or more vehicle controller VC issue(s) at least movement commands to the autonomous transport vehicles 110, 262 of the automated storage and retrieval system 100. The one or more vehicle controller VC may be a part of one or more of the controller 120, warehouse management system 2500, or otherwise disposed so as to be accessible to the one or more the controller 120 and warehouse management system 2500. The vehicle controller VC may be a controller 110C, 262C of an autonomous transport vehicle 110, 262, where the controller 110C, 262C generates the route legs in a manner substantially similar to that described in U.S. Pat. No. 11,760,570 issued on Sep. 19, 2023, the disclosure of which is incorporated herein by reference in its entirety. The unplanned route legs URL may be stored in memory 120M, 2500M or any other suitable location accessible by the control system 100CS (the unplanned route legs may be read by the control system 100CS directly from the one or more vehicle controller VC without storage in memory 120M, 2500M).

For each large fleet 110LF, 262LF, the controller, such as one or more of control server 120 and warehouse management system 2500 system, divides all of the unplanned route legs URL into the sequence of batches BRL and plans the trajectories and paths a batch of route legs. Each of the batches BRL are created by the controller by assigning the unplanned route legs URL respective deferral penalties and collecting the unplanned route legs URL into a batch BRL, where each batch BRL has a predetermined maximum number of route legs therein. The predetermined maximum number of route legs may be user-defined maximum number or defined in any other suitable manner. Route legs with higher deferral penalties are collected into and analyzed in batches prior to analyzation of batches including route legs having lower deferral penalties. Dividing the unplanned route legs URL into batches BRL specifies priorities between batches where the priority-based divide and search autonomous transport vehicle path planning process PBDS treats planned trajectories and paths for previously planned route legs as dynamic obstacles for route legs that are planned in a subsequently (lower priority) planned batch BRL of route legs (i.e., all of the route legs planned in previous batches implicitly gain higher priorities with respect to unplanned route legs of unplanned batches).

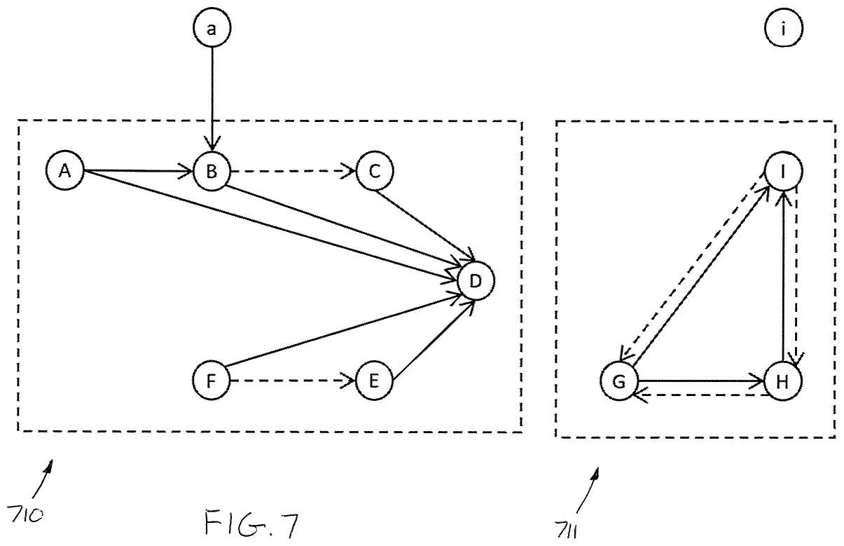

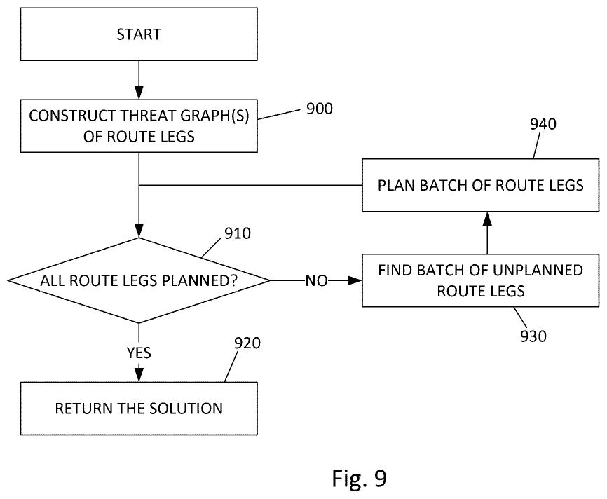

The deferral penalty employed, when assigning route legs into a respective batch BRL of the sequence BRLS, represents how much deferring a route leg into a later or subsequent (lower priority) batch BRL impairs the quality of the planning solution. The deferral penalty evaluation of the unplanned route legs URL is based on a notion of what may be referred to as threats (i.e., where threat refers to an effect a higher priority route leg has on a lower priority route leg). Threat graph(s) (see FIG. 7) may be constructed (FIG. 9, Block 900) for employment in the planning process as described herein. For example, where one unplanned route leg URL is put into a subsequent batch relative to another unplanned route leg (i.e., the one unplanned route leg has a lower priority than the other route leg), the one route leg may be delayed, fail to reach its goal, or result in the respective autonomous transport vehicle 110 being unable to remain at a current location, the higher priority route leg (in this example the other route leg) is considered a threat to the lower priority route leg (in this example, the one route leg). The threats may be qualitatively divided into three types (e.g., delay, reachability, and safety) where the three types of threats define different levels of threat severity. With the notion of threats, a threat graph (see FIG. 7—as described herein) may be constructed and the route leg deferral penalty may be evaluated by the control system 110CS as a severity of being threatened by route legs in a batch of route legs that is currently being planned (i.e., a current batch of route legs).

The controller, such as one or more of control server 120 and warehouse management system 2500, determines if all route legs have been planned (FIG. 9, Block 910). Where all route legs have been planned, the planning solution is returned (FIG. 9, Block 920) and the corresponding autonomous transport vehicle(s) 110, 262 are commanded by the controller 120, 2500 to execute the plan(s). Where all route legs are not planned, the controller 120, 2500 plans later or subsequent batches BRL of route legs (FIG. 9, Blocks 930 and 940), for the respective large fleet 110LF, 262LF, avoiding the trajectories and paths of the route legs (whose trajectories and paths were) planned in previously planned batches BRL of route legs for the respective large fleet 110LF, 262LF (i.e., as noted above, path planning for each large fleet is performed independent of path planning for each other large fleet). Planning may continue in a loop at least until all route legs have been planned (see FIG. 9).

Referring again to FIG. 1, in accordance with the present disclosure the automated storage and retrieval system 100 may operate in a retail distribution center, warehouse, or the back of a retail store. The automated storage and retrieval system 100 may operate to, for example, fulfill orders received from retail stores for case units such as those described in U.S. Pat. No. 10,822,168 issued on Nov. 3, 2020 and U.S. patent application Ser. No. 17/358,383 filed on Jun. 25, 2021, the disclosures of which are incorporated by reference herein in their entireties. For example, the case units are cases or units of goods not stored in trays, on totes or on pallets (e.g. uncontained). In other examples, the case units are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. In accordance with the present disclosure, shipping cases for case units (e.g. cartons, barrels, boxes, crates, jugs, or any other suitable device for holding case units) may have variable sizes and may be used to hold case units in shipping and may be configured so they are capable of being palletized for shipping or sent to a downstream logistics process (e.g., such as goods to person automation) without being palletized. The case units may be segmented case units that include multiple order profiles in one case unit (e.g., such as a segmented tote). The segmented case unit may increase the product density within the case unit and any downstream logistics (e.g., downstream packaging solution such as the goods to person automation). It is noted that when, for example, bundles or pallets of case units arrive at the storage and retrieval system the content of each pallet may be uniform (e.g. each pallet holds a predetermined number of the same item—one pallet holds soup and another pallet holds cereal) and as pallets leave the storage and retrieval system the pallets may contain any suitable number and combination of different case units (e.g. a mixed pallet where each mixed pallet holds different types of case units—a pallet holds a combination of soup and cereal) that are provided to, for example the palletizer in a sorted arrangement for forming the mixed pallet. In the present disclosure the storage and retrieval system 100 described herein may be applied to any environment in which case units are stored and retrieved.

Also referring to FIG. 1D, it is noted that when, for example, incoming bundles or pallets (e.g. from manufacturers or suppliers of case units arrive at the storage and retrieval system for replenishment of the automated storage and retrieval system 100, the content of each pallet may be uniform (e.g. each pallet holds a predetermined number of the same item-one pallet holds soup and another pallet holds cereal). The cases of such pallet load may be substantially similar or in other words, homogenous cases (e.g. similar dimensions), and may have the same SKU (otherwise, as noted before the pallets may be “rainbow” pallets having layers formed of homogeneous cases). As pallets PAL leave the storage and retrieval system 100, with cases filling replenishment orders, the pallets PAL may contain any suitable number and combination of different case units CU (e.g., each pallet may hold different types of case units-a pallet holds a combination of canned soup, cereal, beverage packs, cosmetics and household cleaners). The cases combined onto a single pallet may have different dimensions and/or different SKU's. In one aspect of the present disclosure, the storage and retrieval system 100 may be configured to generally include an in-feed section, a storage and sortation section (where, in one aspect, storage of items is optional) and an output section as will be described in greater detail below. In the present disclosure the system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and assemble the corresponding groups of cases into what may be referred to as mixed case pallet loads MPL. In the present disclosure the system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and sequence the corresponding groups of cases in the manner described in U.S. Pat. No. 9,856,083 issued on Jan. 2, 2018, the disclosure of which is incorporated herein by reference in its entirety.

The storage and sortation section includes a multilevel automated storage system that has an automated transport system that in turn receives or feeds individual cases into the multilevel storage array SA for storage in a storage area (such as storage spaces 130S of the storage structure 130). The storage and sortation section may define outbound transport of case units from the multilevel storage array such that desired case units are individually retrieved in accordance with commands generated in accordance to orders entered into a warehouse management system, such as warehouse management system 2500, for transport to the output section. The storage and sortation section may receive individual cases, sort the individual cases (utilizing, for example, the buffer and interface stations described herein), e.g., in a case level sortation, and transfer the individual cases to the output section in accordance to orders entered into the warehouse management system. The sorting and grouping of cases according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015, the disclosure of which is incorporated herein by reference in its entirety.

The output section generates the pallet load in what may be referred to as a structured architecture of mixed case stacks. The structured architecture of the pallet load described herein is representative and in other aspects, the pallet load may have any other suitable configuration. For example, the structured architecture may be any suitable predetermined configuration such as a truck bay load or other suitable container or load container envelope holding a structural load. The structured architecture of the pallet load may be characterized as having several flat case layers L121-L125, L12T as described in U.S. Pat. No. 9,856,083, previously incorporated by reference herein in its entirety.

Referring again to FIG. 1, the automated storage and retrieval system 100 may include a storage array (e.g., storage structure 130 having storage spaces 130S) with at least one elevated storage level 130L and at least one breakpack module 266 (as described herein). It is noted that while the storage array is described as a three dimensional storage array, the storage array may be a two dimensional storage array (e.g., single level floor), the back of a truck, or any other suitable storage array where case units may be transferred directly by the storage and retrieval system 100 (such as by the autonomous guided container bots 110) or indirectly (e.g., by fork trucks or other vehicle/operator placing case units on a conveyor in a predetermined sequence (grouped stock keeping units or other categorical sequencing)) to a breakpack module 266. Where the storage array is a single level (i.e., single level floor) the breakpack module 266 is located on the floor level of the storage array. Mixed product units are input and distributed in the storage array in cases CU of product units of common kind per case CU (each case input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers) to lift modules 150A for entry into a storage level 130L of the storage structure 130).

The automated storage and retrieval system 100 includes an automated transport system (e.g., autonomous container transport vehicles or autonomous guided container bots 110, autonomous goods transport vehicles or autonomous guided goods bots 262, breakpack modules, and other suitable level transports described herein) with at least one asynchronous transport system for transporting cases/products on a given storage structure level 130L (e.g., level transport). As will be described, the storage and retrieval system 100 may include non-holonomic autonomous guided container bots 110 that undeterministically (i.e., are not physically constrained for travel along a given path, not restricted to Cartesian motion, and not restricted to travel lanes of a Cartesian grid of travel lanes) travel along one or more physical pathways (such as described with respect to FIGS. 4-5B) of the storage and retrieval system 100 to provide at least one level of asynchronicity. The autonomous guided container bots 110 of each respective storage level 130L may be confined to the respective storage level 130L such that each storage level has a respective large fleet 110LF of autonomous guided container bots 110 for which path planning is determined as described herein independent of other large fleets 110LF of other storage levels 130L. The storage structure may be configured such that autonomous guided container bots 110 may travel between two or more storage levels 130L such that the large fleet 110LF includes the autonomous guided container bots 110 of the two or more storage levels 130L. The autonomous guided container bots 110 are configured for high speed travel, where the high speed travel is greater than about 1 m/sec or more with the container bot 110 carrying a payload of about 60 lbs (about 27 kg) to about 90 lbs (about 41 kg) (in other aspects the payload may be less than about 60 lbs or more than about 90 lbs). In accordance with another example, the high speed travel of the container bot 110 may be in excess of about 20 km/hr (e.g. about 5.6 m/sec) and more particularly about 32 km/hr (e.g. about 9.144 m/sec) or about 36 km/hr (e.g. about 10 m/sec) with the container bot 110 carrying a payload of about 60 lbs (about 27 kg) to about 90 lbs (about 41 kg) (in other aspects the payload may be less than about 60 lbs or more than about 90 lbs).

At least another level of asynchronicity is provided (as described herein) such that, for example, case/product holding locations are greater than the number of bots transporting cases/products. At least one lift 150 is provided for transporting cases/products between storage levels (e.g., between level transport) or the cases/products may be presorted an on a predetermined level before a container bot 110 retrieves the cases/products (e.g., such that the lift does not transfer the cases/products between levels for container bot 110 retrieval). The at least one lift 150B is communicably connected to the storage array as described herein so as to automatically retrieve and output, from the storage array, product units distributed in the cases in a common part (e.g., the storage locations 130S of a respective storage level 130L) of the at least one elevated storage level 130L of the storage array. The output product units being one or more of mixed singulated product units, in mixed packed groups, and in mixed cases. The automated storage and retrieval system 100 may include output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). Here the output station 160EC is an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT is a commercial output station where large numbers of goods are generally provided on pallets for fulfilling orders from commercial entities (e.g., commercial stores, warehouse clubs, restaurants, etc.). The automated storage and retrieval system 100 may include both the commercial output station 160UT and the individual fulfillment output station 160EC; although, the automated storage and retrieval system may include one or more of the commercial output station 160UT and the individual fulfillment output station 160EC.

The automated storage and retrieval system 100 also includes the input and output vertical lift modules 150A, 150B (generally referred to as lift modules 150—it is noted that while input and output lift modules are shown, a single lift module may be used to both input and remove case units from the storage structure), a storage structure 130 (which may have at least one elevated storage level as noted above and in some aspects forms a multilevel storage array), and at least one autonomous guided container bot 110 (which form at least a part of the asynchronous transport system for level transport) which may be confined to a respective storage level of the storage structure 130 and are distinct from a container transfer deck 130DC on which they travel. The lift modules 150 include any suitable transport configured to vertically raise and lower case units and are inclusive of reciprocating elevator type lifts, fork lift trucks, etc. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL (FIG. 1D) for shipping. As used herein the lift modules 150, storage structure 130 and autonomous guided container bots 110 may be collectively referred to herein as the multilevel automated storage system (e.g. storage and sorting section) noted above so as to define (e.g. relative to e.g. a container bot 110 frame of reference REF—FIG. 4A—or any other suitable storage and retrieval system frame of reference) transport/throughput axes (in e.g. three dimensions) that serve the three dimensional multilevel automated storage system where each throughput axis has an integral “on the fly sortation” (e.g. sortation of case units during transport of the case units) so that case unit sorting and throughput occurs substantially simultaneously without dedicated sorters as described in U.S. Pat. No. 9,856,083, previously incorporated herein by reference in its entirety.

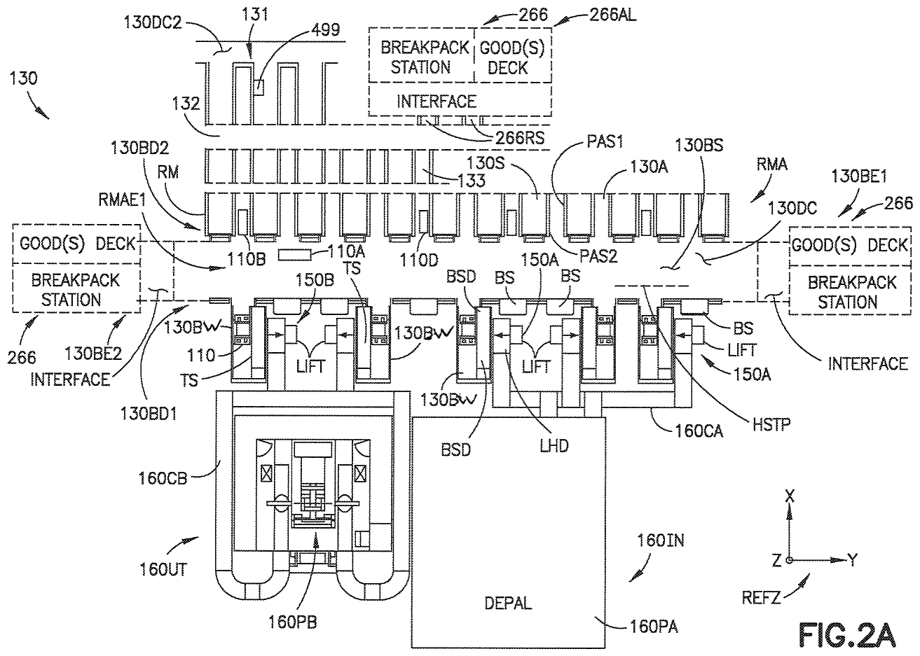

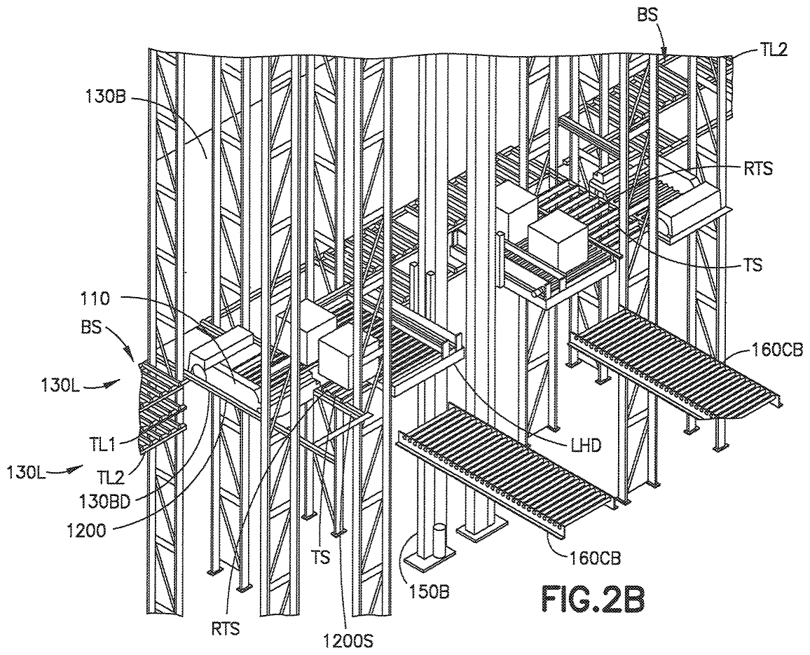

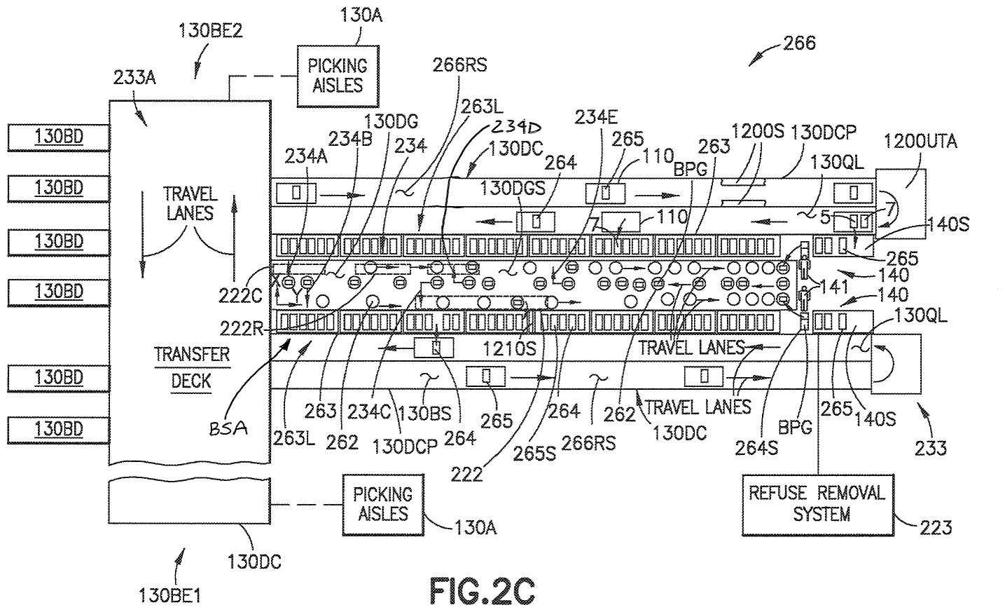

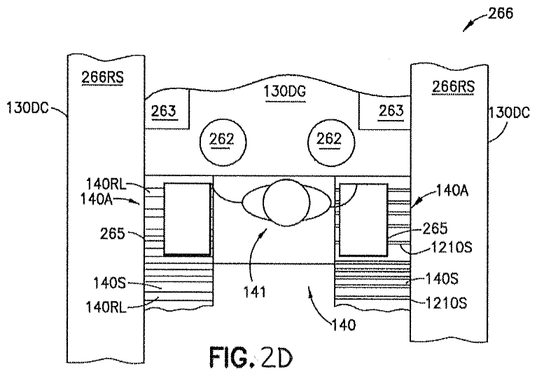

Also referring to FIGS. 1, 1C, 2A, and 2C, the storage structure 130 may include a container autonomous transport travel loop(s) 233, 233A (e.g., formed on and along a container transfer deck 130DC), disposed at a respective level of the storage structure 130. It is noted that the lifts 150 are connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) (see FIG. 2C) and the breakpack goods containers 264 (empty or filled) (see FIG. 2C) into and out of the at least one elevated storage level 130L of the storage structure 130. Container storage locations (or spaces) 130S are arrayed peripherally along the container transfer deck 130DC. For example, multiple storage rack modules RM, configured in a high-density three dimensional rack array RMA, are accessible by storage or deck levels 130L. As used herein the term “high density three dimensional rack array” refers to the three dimensional rack array RMA having undeterministic open shelving distributed along picking aisles 130A where, multiple stacked shelves may be accessible from a common picking aisle travel surface or picking aisle level as described in U.S. Pat. No. 9,856,083, previously incorporated by reference herein in its entirety.

Each storage level 130L includes pickface storage/handoff spaces 130S (referred to herein as storage spaces 130S or container storage locations 130S) arrayed peripherally along the container transfer deck 130DC. At least one of the storage locations 130S is a supply container storage location 130SS, and another of the container storage locations is a breakpack goods (or order) container storage location 130SB. The storage spaces 130S are in one aspect formed by the rack modules RM where the rack modules include shelves that are disposed along storage or picking aisles 130A (that are connected to the container transfer deck 130DC) which, e.g., extend linearly through the rack module array RMA and provide container bot 110 access to the storage spaces 130S and transfer deck(s) 130B. The shelves of the rack modules RM may be arranged as multi-level shelves that are distributed along the picking aisles 130A. The autonomous guided container bots 110 travel on a respective storage level 130L along the picking aisles 130A and the container transfer deck 130DC for transferring case units between any of the storage spaces 130S of the storage structure 130 (e.g. on the level which the container bot 110 is located) and any of the lift modules 150 (e.g. each of the autonomous guided container bots 110 has access to each storage space 130S on a respective level and each lift module 150 on a respective storage level 130L). The transfer decks 130B are arranged at different levels (corresponding to each level 130L of the storage and retrieval system) that may be stacked one over the other or horizontally offset, such as having one container transfer deck 130DC at one end or side RMAE1 of the storage rack array RMA or at several ends or sides RMAE1, RMAE2 of the storage rack array RMA as described in, for example, U.S. patent application Ser. No. 13/326,674 filed on Dec. 15, 2011 the disclosure of which is incorporated herein by reference in its entirety.

The container transfer decks 130DC are substantially open and configured for the undeterministic traversal of autonomous guided container bots 110 along multiple travel lanes (e.g. along an X throughput axis with respect to the bot frame of reference REF illustrated in FIG. 4A) across and along the transfer decks 130B. As will be described in further detail below (and as described in U.S. Pat. No. 10,556,743 issued on Feb. 11, 2020 and having application Ser. No. 15/671,591, the disclosure of which is incorporated herein by reference in its entirety) the multiple travel lanes may be configured to provide multiple access paths or routes to each storage location 130S (e.g., pickface, case unit, container, or other items stored on the storage shelves of rack modules RM) so that autonomous guided container bots 110 may reach each storage location using, for example, a secondary path if a primary path to the storage location is obstructed. The transfer deck(s) 130B at each storage level 130L communicate with each of the picking aisles 130A on the respective storage level 130L. Autonomous guided container bots 110 bi-directionally traverse between the container transfer deck(s) 130DC and picking aisles 130A on each respective storage level 130L so as to travel along the picking aisles (e.g. along the X throughput axis with respect to the bot frame of reference REF illustrated in FIG. 4A) and access the storage spaces 130S disposed in the rack shelves alongside each of the picking aisles 130A (e.g. autonomous guided container bots 110 may access, along a Y throughput axis, storage spaces 130S distributed on both sides of each aisle such that the container bot 110 may have a different facing when traversing each picking aisle 130A, for example, referring to FIG. 4A, drive wheels 202 leading a direction of travel or drive wheels trailing a direction of travel). Throughput outbound from the storage array in the horizontal plane corresponding to a predetermined storage or deck level 130L is effected by and manifest in the combined or integrated throughput along both the X and Y throughput axes. As noted above, the container transfer deck(s) 130DC may provide container bot 110 access to each of the lifts 150 on the respective storage level 130L where the lifts 150 feed and remove case units (e.g. along the Z throughput axis) to and/or from each storage level 130L and where the autonomous guided container bots 110 effect case unit transfer between the lifts 150 and the storage spaces 130S.

As described above, referring also to FIG. 2A, the storage structure 130 may include multiple storage rack modules RM, configured in a three dimensional array RMA where the racks are arranged in aisles 130A, the aisles 130A being configured for container bot 110 travel within the aisles 130A. The container transfer deck 130DC has an undeterministic transport surface on which the autonomous guided container bots 110 travel where the undeterministic transport surface (also referred to herein as a deck surface) 130BS has multiple travel lanes (e.g., more than one juxtaposed travel lane (e.g. high speed bot travel paths HSTP)) for travel of the container bot 110 along the container autonomous transport travel loop(s) 233, 233A formed by the container transfer deck 130DC, where the multiple travel lanes connect the aisles 130A. The container autonomous transport travel loop 233A provides the container bot 110 with random access to any and each picking aisle 130A and random access to any and each lift 150A, 150B on the respective level 130L of the storage structure 130. At least one of the multiple travel lanes has a travel sense opposite to another travel lane sense of another of the multiple travel lanes (so as to form the container autonomous transport travel loop 233).

Any suitable controller of the storage and retrieval system 100 such as for example, control server 120, may be configured to create any suitable number of alternative pathways for retrieving one or more case units (and/or breakpack containers) from their respective storage locations 130S when a pathway provided access to those case units is restricted or otherwise blocked. For example, the control server 120 may include suitable programming, memory and other structure for analyzing the information sent by the container 110, lifts 150A, 150B, and input/output stations 160IN, 160UT, 160EC for planning a container bot's 110 primary or preferred route to a predetermined item within the storage structure. The preferred route may be the fastest and/or most direct route that the container bot 110 can take to retrieve the case units/pickfaces. The preferred route may be any suitable route. The control server 120 may also be configured to analyze the information sent by the autonomous guided container bots 110, the lifts 150A, 150B, and input/output stations 160IN, 160UT, 160EC for determining if there are any obstructions along the preferred route. If there are obstructions along the preferred route the control server 120 may determine one or more secondary or alternate routes for retrieving the case units so that the obstruction is avoided and the case units can be retrieved without any substantial delay in, for example, fulfilling an order. It should be realized that the container bot route planning may also occur on the container bot 110 itself by, for example, any suitable control system, such as a controller (system) 110C onboard the container bot 110. As an example, the bot control system may be configured to communicate with the control server 120 for accessing the information from other autonomous guided container bots 110, the lifts 150A, 150B, and the input/output stations 160IN, 160UT, 160EC for determining the preferred and/or alternate routes for accessing an item in a manner substantially similar to that described above. It is noted that the container bot 110 controller 110C may include any suitable programming, memory and/or other structure to effect the determination of the preferred and/or alternate routes.

Referring to FIG. 2A, as a non-limiting example, in an order fulfillment process the container bot 110A, which is traversing container transfer deck 130DC, may be instructed to retrieve item 499 from picking aisle 131. However, there may be a disabled bot 110B blocking aisle 131 such that the bot 110A cannot take a preferred (e.g. the most direct and/or fastest) path to the case unit 499. In this example, the control server 120 may instruct the container bot 110A to traverse an alternate route such as through any unreserved picking aisle (e.g. an aisle without a container bot in it or an aisle that is otherwise unobstructed) so that the container bot 110A can travel along, for example, another container transfer deck 130DC2 that is substantially similar to container transfer deck 130DC. The container bot 110A can enter the end of the picking 131, opposite the blockage, from the other container transfer deck 130DC2 so as to avoid the disabled container bot 110B for accessing the item 499. In another aspect, the storage and retrieval system 100 may include one or more bypass aisles 132 that run substantially transverse to the picking aisles 130 to allow the autonomous guided container bots 110 to move between picking aisles 130 in lieu of traversing the container transfer decks 130DC, 130DC2. The bypass aisles 132 may be substantially similar to travel lanes of the container transfer decks 130DC, 130DC2, as described herein, and may allow bidirectional or unidirectional travel of the autonomous guided container bots through the bypass aisle 132. The bypass aisle 132 may provide one or more lanes of container bot travel where each lane has a floor and suitable guides for guiding the bot along the bypass aisle 132 in a manner similar to that described herein with respect to the transfer decks 130DC, 130DC2. The bypass aisles 132 may have any suitable configuration for allowing the autonomous guided container bots 110 to traverse between the picking aisles 130. It is noted that while the bypass aisle 132 is shown with respect to a storage and retrieval system having transfer decks 130DC, 130DC2 disposed on opposite ends of the storage structure, in other aspects, a storage and retrieval system 100 having only one transfer deck may also include one or more bypass aisles 132.

A breakpack module 266AL may be located on a side of the container transfer deck 130DC on which the picking aisles 130 are located and one or more picking aisles 130 extend into the breakpack module 266AL so as to form container bot riding surface(s) 266RS. Here the container bot 110A is to deliver a supply container 265 to the breakpack module 266AL and the picking aisle 133 extending into the breakpack module is blocked by container bot 110D. The control server 120 and/or container bot controller 110C may determine a secondary or bypass route for the container bot 110A to access breakpack station (either travelling along the other container transfer deck 130DC2 and/or bypass aisle 132) in a manner substantially similar to that described above with respect to item 499.

It is noted that the storage and retrieval systems shown and described herein have exemplary configurations only and in other aspects the storage and retrieval systems may have any suitable configuration and components for storing and retrieving items as described herein. For example, the storage and retrieval system may have any suitable number of storage sections, any suitable number of transfer decks, any suitable number of breakpack modules, and corresponding input/output stations.

The juxtaposed travel lanes are juxtaposed along a common undeterministic transport surface 130BS between opposing sides 130BD1, 130BD2 of the container transfer deck 130DC. As illustrated in FIG. 2A, the aisles 130A may be joined to the container transfer deck 130DC on one side 130BD2 of the container transfer deck 130DC although, the aisles may be joined to more than one side 130BD1, 130BD2 of the container transfer deck 130DC in a manner substantially similar to that described in U.S. patent application Ser. No. 13/326,674 filed on Dec. 15, 2011, the disclosure of which is previously incorporated by reference herein in its entirety. As will be described in greater detail below the other side 130BD1 of the container transfer deck 130DC may include includes deck storage racks (e.g. interface stations (also referred to as transfer stations) TS and buffer stations BS) that are distributed along the other side 130BD1 of the container transfer deck 130DC so that at least one part of the transfer deck is interposed between the deck storage racks (such as, for example, buffer stations BS or transfer stations TS) and the aisles 130A. The deck storage racks are arranged along the other side 130BD1 of the container transfer deck 130DC so that the deck storage racks communicate with the autonomous guided container bots 110 from the container transfer deck 130DC and with the lift modules 150 (e.g. the deck storage racks are accessed by the autonomous guided container bots 110 from the container transfer deck 130DC and by the lifts 150 for picking and placing pickfaces so that pickfaces are transferred between the autonomous guided container bots 110 and the deck storage racks and between the deck storage racks and the lifts 150 and hence between the autonomous guided container bots 110 and the lifts 150).

Referring again to FIG. 1, each storage level 130L may include charging stations 130C for charging an on-board power supply of the autonomous guided container bots 110 on that storage level 130L such as described in, for example, U.S. patent application Ser. No. 14/209,086 filed on Mar. 13, 2014 and Ser. No. 13/326,823 filed on Dec. 15, 2011 (now U.S. Pat. No. 9,082,112), the disclosures of which are incorporated herein by reference in their entireties.

Referring to FIGS. 1, 2A, 2C, as noted above, the automated storage and retrieval system 100 may include one or more break pack modules 266. The breakpack modules 266 are configured to break down product containers or case units CU into breakpack goods containers 264 for order fulfillment, such as described in U.S. patent application Ser. No. 17/358,383 filed Jun. 25, 2021, the disclosure of which was previously incorporated herein by reference in its entirety. The breakpack modules 266 may operate as an automated decant process for downstream logistics such as goods to person automation. One or more breakpack modules 266 may be located on a common level 130L of the automated storage and retrieval system, where one or more levels of the automated storage and retrieval system 100 include at least one breakpack module 266. The breakpack module(s) 266 may be plug and play modules that may be coupled to any suitable portion of the structure of the automated storage and retrieval system 100. For example, the breakpack module(s) may be coupled to a container transfer deck 130DC or picking (or pick) aisle(s) 130A of the automated storage and retrieval system 100 as will be described in greater detail below. The breakpack module(s) 266 may be disposed on any suitable number of stacked storage levels of the automated storage and retrieval system 100. Here, the automated storage and retrieval system 100 may be configured, such as through any suitable controller (e.g., control server 120) so that the automated storage and retrieval system 100 has selectable modes of operation. In one mode of operation the automated storage and retrieval system 100 is configured to output product cases, containers, and/or case units to a palletizer. In another mode of operation, such as with the breakpack module(s) 266 employed, the automated storage and retrieval system 100 is configured to break down product cases, product containers, and/or case units and output breakpack goods containers, product cases, containers, and/or case units to a palletizer, or in other aspects, re-enter the breakpack (order) container(s) and/or a remainder of a product cases, containers, and/or case units to a palletizer (e.g., after being broken down) into storage for later retrieval.

The controller 120 (or warehouse management system 2500), may be configured to plan travel paths and effect operation of a container bot 110 and an autonomous guided goods bot 262 (both of which form at least part of the asynchronous transport system) (see also, e.g., FIG. 2C) for assembling orders of breakpack goods BPG from supply containers 265 into breakpack goods containers 264 and outfeed of breakpack goods containers 264 through container outfeed stations TS as will be described herein. The controller 120 (or warehouse management system 2500) may be configured to effect operation of the container bot(s) 110 between the container storage locations 130S, the breakpack operation station 140, and a breakpack goods container 264 located along the breakpack goods transfer deck 130DG. As another example, the controller 120 is configured to effect operation of the autonomous guided goods bot(s) 262 so that transport of the breakpack goods BPG, by the autonomous guided goods bot 262 traverse on the goods transfer deck 130DG, sorts the breakpack goods BPG, e.g., in a unit/each level sortation, to corresponding breakpack goods containers 264. The controller 120 may be configured to effect operation of the container bot(s) 110 so that the container bot(s) 110 accesses corresponding breakpack goods containers 264 at the goods transfer deck 130DG and transports the breakpack goods containers 264 via traverse along the container transfer deck 130DC to at least one of a container output/transfer station TS and a corresponding container storage location 130SB of storage shelves of a corresponding level 130L of the multilevel storage array.

The controller 120 (or warehouse management system 2500) may be configured to plan travel paths and effect operation of the container bot(s) 110 and effect operation of lifts 150 (e.g., to form a container supply system) so as to introduce empty breakpack goods containers 264 into the automated storage and retrieval system so that the container bot(s) 110 transport the empty breakpack goods containers 264, along the transport loops 233, 233A of the container transfer deck(s) 130DC and into a breakpack module 266 for placement at a breakpack goods interface location(s) 263L of a breakpack goods interface 263 for transfer of breakpack goods BPG into the breakpack goods containers 264. Empty breakpack containers 264 may be transferred to (in a manner similar to that noted above with the lifts and autonomous guided container bots) and stored in the storage spaces 130SB, 130S of the rack modules RM or buffered at an infeed station, where the controller 120 is configured to effect transfer of the empty breakpack goods containers 264 from the storage spaces 130SB, 130S or buffer location to the breakpack goods interface 263 in a manner similar to that described above. The controller 120 may be configured to effect operation of the container bot(s) 110 and lifts 150 (e.g., forming a container supply system) so as to introduce empty supply containers 265 or standardized containers 265S (as described herein) into the automated storage and retrieval system so that the container bot(s) 110 transport the empty supply containers 265 or standardized containers 265S, along the transport loops 233, 233A of the container transfer deck(s) 130DC and to the breakpack operation station 140 of a breakpack or directly or indirectly to a downstream logistics process such as the goods to person process.

Each breakpack module 266 may have a container bot riding surface 266RS that forms a portion 130DCP of the container transfer deck 130DC, where the riding surface 266RS is substantially similar to that of container transfer deck 130DC, while in other aspects the container bot riding surface 266RS may be substantially similar to that of the picking aisles 130A. For ease of explanation, the aspects of the present disclosure will refer to the container bot riding surface 266RS within the breakpack module 266 as a portion of the container transfer deck 130DC. Where the bot riding surface 266RS is formed by a portion of (or is an extension of) the container transfer deck 130DC it is noted that, while the container transfer deck 130D is illustrated in FIG. 2C a single path transport loop, in other aspects the transport loop of the breakpack module 266 may be a multilane transport loop substantially similar to container transport deck illustrated in FIG. 2A. For example, referring to FIG. 2E the container bot travel surface 266RS is an open undeterministic travel surface having multiple travel inbound and outbound lanes. For example, there are multiple inbound travel lanes TL1, TL2 where travel lane TL2 is a bypass lane for travelling around obstructions on travel lane TL1 (or vice versa). There may also be multiple outbound travel lanes TL3, TL4, TL5. Here, travel lane TL5 defines a queue lane 130QL (FIG. 2C) for the autonomous guided container bots 110 at the breakpack goods interface 263 while travel lanes TL4 and TL5 may be used for egress from the breakpack module 266, with travel lane TL5 being a bypass for travelling around obstructions on travel lane TL4 (or vice versa). Case units may be transferred between the storage array and the breakpack module 266 indirectly, such as by conveyors and/or fork trucks. In one or more aspects, the autonomous guided container bots 110 or fork trucks may deliver case units to conveyors that transport the case units to the breakpack station and from the breakpack station to the storage array or downstream logistics process.

Each of the breakpack modules 266 includes a breakpack goods autonomous transport travel loop 234 (see exemplary breakpack goods autonomous transport travel loops 234A-234E formed on and along a goods deck or goods transfer deck 130DG), at least one breakpack operation station 140, and a breakpack goods interface 263 disposed between and interfacing the goods transfer deck 130DG with the container transfer deck 130DC. Referring also to FIGS. 1 and 2A, the breakpack goods module 266 may include one or more belt sorters BST (such as cross belt sorters) that is/are configured as an interface(s) between autonomous guided goods bots 262 (operating on the goods deck 130DG) and the autonomous guided container bots 110 (operating on the container transport deck 130DC), between the autonomous guided container bots 110 and the breakpack operation station 140, and/or between the breakpack operation station 140 and the autonomous guided goods bots 262. For exemplary purposes only, the goods deck 130DG is illustrated as having three travel lanes that form the (variable length) travel loops 234A-234E; however, the goods deck may have any suitable number of travel lanes that form any suitable number of breakpack goods autonomous transport travel loops 234. Each breakpack module 266 may be undeterministically coupled (e.g., the breakpack modules 266 maybe coupled to the automated storage and retrieval system 100 at any suitable location thereof, such as to one or more ends 130BE1, 130BE2, or centrally located between the two ends 130BE1, 130BE2 such as in place of picking aisles 130 (and storage locations) or at any other suitable location) to the automated storage and retrieval system 100 in any suitable manner (e.g., so as to form a part thereof). Though the breakpack modules 266 are coupled undeterministically to the structure of the automated storage and retrieval system 100 each component of the breakpack modules 166 is independent (e.g., self-contained as a unit) and/or independently automated in guidance and travel of the bots (e.g., autonomous guided goods bots 262) from the components of the automated storage and retrieval system, so that the interface between the components of the breakpack modules 266 and the components of the automated storage and retrieval system 100 is undeterministic.

The breakpack module(s) 266 may be coupled to the structure of the automated storage and retrieval system 100 at any suitable location and at any suitable level(s) 130L. For example, as noted above, a break pack module 266 may be located at one or more ends 130BE1, 130BE2 of the container transfer deck 130DC or at one or more sides 130BD1, 130BD2 of the container transfer deck 130DC (such as in lieu of storage rack modules RM/picking aisles 130A or lifts 150A, 150B, or as an extension of one or more picking aisles 130A). Each of the breakpack modules 266 is a plug and play module that is integrated with (or otherwise connected to) the container transfer deck 130DC so that the container transfer deck 130DC is communicably coupled to the container bot riding surface 266RS. The container transfer deck 130DC may extend into the breakpack module to form the container bot riding surface 266RS (e.g., the breakpack module forms a modular part of the container transfer deck 130DC) so that autonomous guided container bots 110 traverse or move into and out of the breakpack modules 266 along the undeterministic container transfer deck 130DC, and at least one of the multiple travel lanes of the container transfer deck 130DC defines a queue lane 130QL (FIG. 2C) for the autonomous guided container bots 110 at the breakpack goods interface 263. The container bot riding surface 266RS may include rails 1200S (see FIG. 1B) that extend from the container transport deck 130DC in a manner similar to that of the picking aisles 130A, so that autonomous guided container bots 110 traverse or move into and out of the breakpack modules 266 along the rails 1200S, and the rails 1200S defines a queue lane 130QL (FIG. 2C) for the autonomous guided container bots 110 at the breakpack goods interface 263. It is noted that where the container bot riding surface 266RS is formed by rails 1200S the riding surface may include an undeterministic turn around area 1200UTA (that is similar to the open undeterministic container transfer deck 130DC) on which the autonomous guided container bots 110 turn to transition between different travel portions (e.g., inbound and outbound) of the breakpack goods autonomous transport travel loop 234. As can be seen in FIG. 2C, the container bot travel surface 266RS of the breakpack module 266 forms a travel loop 233 around which the autonomous guided container bots 110 travel to respectively transport along the container bot travel surface 266RS travel loop 233 a supply container (e.g., case unit, pickface, remainder container, etc.) between the storage locations 130S and a breakpack operation station 140 (and/or vice versa), and a breakpack goods container (also referred to as a breakpack container) 264 between the breakpack goods interface 263 and the breakpack goods container storage location 130SB or a lift 150A (and/or vice versa). The travel loop 233 provides the container bot 110 with random access to any and each breakpack goods interface locations 263L of the breakpack goods interface 263 along the bot travel surface 266RS, where the breakpack goods interface locations 263L form an asynchronous product distribution system.

The goods transfer deck 130DG forms a goods autonomous transport travel loop 234 disposed at the storage level 130L. The goods transfer deck 130DG is separate and distinct from the travel loop 233 formed by the container bot travel surface 266RS, and has the breakpack goods interface 263 coupling respective edges of the container autonomous transport travel loop 233 of the container transfer deck 130DC and the breakpack goods autonomous transport travel loop 234 of the goods transfer deck 130DG. The goods autonomous transport travel loop 234 formed by the goods transfer deck 130DG is disposed on a deck surface 130DGS of a deck (e.g., goods transfer deck 130DG) at a respective storage level 130L, and the breakpack goods autonomous transport travel loop(s) 234 of the goods transfer deck 130DG is disposed on a different deck surface 130DGS of the deck (e.g., goods transfer deck 130DG), separate and distinct from the deck surface 130BS of the container bot travel surface 266RS (formed by the container transfer deck 130DC and/or rails 1200S) where the container autonomous transport travel loop 233 is disposed. The breakpack goods autonomous transport travel loop 234 formed by the goods transfer deck 130DG (and hence the goods travel deck 130DG) is disposed to confine at least one autonomous goods bot 262 to the respective storage level 130L. The at least one autonomous guided goods bot 262 is arranged or otherwise configured for transporting, along the breakpack goods autonomous transport travel loop 234 formed by the goods transfer deck 130DG, one or more breakpack goods BPG (e.g., a pack that is unpacked from the supply container in a pack level sort or a unit/each unpacked from a pack in a unit/each level sort) between the breakpack operation station 140 and the breakpack goods interface 263. The container bot(s) 110 is also configured to autonomously pick and place the breakpack goods containers 264 at the breakpack goods interface 263 as described herein. The breakpack goods interface 263 may be substantially similar to one or more of the transfer stations TS and buffer stations BS described herein and include an undeterministic surface (similar to that of the rack storage spaces 130S described herein) upon which breakpack goods containers 264 are placed so as to form an undeterministic interface between the goods transfer deck 130DG and the container transfer deck 130DC.

The goods transfer deck 130DG may facilitate a decanting process where goods are picked from one container (such as a supply container 265 or any other suitable standardized container 265S) at the breakpack operation station 140 and consolidated with goods (generally of the same type) in another (e.g., outbound as noted below) supply container 265 or standardized container 265S at the breakpack goods interface 263, where the other supply container 265 or standardized container 265S is returned to storage. Generally, supply containers 265 inbound to the breakpack modules 266 are picked until empty but only some (not all) of the goods from the inbound supply container may be decanted. Here, what may be referred to as outbound (i.e., outbound from the breakpack modules 266) supply containers 265 or standardized containers 265S (such as totes, trays, etc.) may be placed on the breakpack goods interface 263 by the container bot(s) 110 in a manner similar to that described herein for the breakpack goods containers 264 to facilitate the decanting process. In the decanting process, goods are removed from a supply container 265 (which may be an original product/good(s) case packaging) at the breakpack operation station 140 and consolidated into the outbound supply container(s) 265 or standardized container 265S (e.g., having the same type of goods as those being removed at the breakpack operation station 140) located on the breakpack goods interface 263. Consolidation of goods having the same type from multiple supply containers 265 into a lesser number of supply containers 265 (and then returned to storage by the container bot(s) 110) may increase the storage density of the automated storage and retrieval system 100 as the supply containers 265 stored in the storage racks can be maintained in a substantially “full” state (rather than having multiple containers that are less than full with the same type of goods therein. In some aspects, the decanted goods (in the standardized container or outbound supply container) are output from the storage and retrieval system 100 via the lifts 150 to be palletized as part of a pallet load (such as at output station 160UT) or to be shipped individually (such as at output station 160EC).

The autonomous guided goods bots 262 may be any suitable type of autonomously guided bot with a payload configured for holding breakpack goods, not product containers (e.g., case units, pickfaces, etc.). Each of the autonomous guided goods bots 262 has a payload hold configured dissimilar from a payload hold of the container bot 110. The autonomous guided goods bots 262 are configured to autonomously travel unconstrained along and across the breakpack goods autonomous transport travel loop(s) 234 formed by the goods deck 130DG and any suitable travel speeds, which may be the same as, greater than, or less than those travel speeds noted above with respect to the autonomous guided container bots 110. The autonomous guided goods bots 262 are configured so as to automatically unload one or more breakpack goods BPG (retrieved from the breakpack operation station 140) from the autonomous guided goods bot 262 to breakpack goods containers 264 at the breakpack goods interface 263. Suitable examples of autonomous guided goods bots 262 include those produced by Symbotic of Wilmington, Massachusetts (United States), see for example, U.S. patent application Ser. No. 17/657,705 filed on Apr. 1, 2022 (Published as US PG Pub 2022/0289479), U.S. Provisional Patent Application No. 63/452,735 filed Mar. 17, 2023; and those produced by Tompkins International of Raleigh, North Carolina (United States), see for example, U.S. Pat. No. 10,248,112 issued on Apr. 2, 2019. The breakpack goods autonomous transport travel loop(s) 234 formed by the goods deck 130DG has multiple travel lanes (see FIG. 2C) for travel of the autonomous guided goods bots 262 along the breakpack goods autonomous transport travel loop(s) 234 (see, e.g., travel loops 234A-234E) formed by the goods deck 130DG. As noted herein, three travel lanes are illustrated for exemplary purposes only and in other aspects there may be more or less than three travel lanes. At least one of the multiple travel lanes is a passing lane for the autonomous guided goods bot 262 travel passing an obstruction on another of the multiple travel lanes in a manner similar to that described herein with respect to the multiple travel lanes of the container transfer deck 130DC. The breakpack goods autonomous transport travel loop(s) 234 provide the autonomous guided goods bots 262 with random access to any and each of the breakpack goods interface locations 263L of the breakpack goods interface 263. In other aspects, the breakpack goods autonomous transport travel loop(s) 234 provide the autonomous guided goods bots 262 access to the belt sorter BST where the belt sorter BST sorts (and may be configured as a sorting buffer) the breakpack goods to the breakpack goods interface 263. Here the belt sorter BST operates as an interface between the autonomous guided goods bots 262 and autonomous guided container bots 110.

One or more portions of the goods transfer deck 130DG (such as adjacent the breakpack goods interface locations 263L) can be reserved to provide an exit (or off) ramp or entrance (or on) ramp from or to a travel loop travel 234A-234E to effect a transfer of breakpack goods BPG to or from the breakpack goods container(s) 264 (or supply containers 265, 265S) at the breakpack goods interface locations 263L. Exit ramps (referred to herein as ramps 222, 222C, 222R) will be described herein but it should be understood that the entrance ramps are substantially opposite in direction to the exit ramps 222, 222C, 222R (e.g., provide access to rather than access from a travel loop). One or more ramps 222, 222C, 333R are provided depending on, for example, bot 110 kinematics (velocity, direction, etc.) and location(s) of (destination) breakpack goods interface locations 263L (e.g., near corners of the goods transfer deck 130DG, away from the corners of the goods transfer deck 130DG, etc.) being accessed by the autonomous guided goods bots 262. For exemplary purposes only, ramp 222 is a generic depiction of an on/off ramp that may be located anywhere on the goods transfer deck 130DG and have any suitable length. Ramp 222C is located in a corner of the goods transfer deck 130DG. Ramp 222R is a “rolling” ramp that moves to follow a path of an autonomous guided goods bot 262 traveling along the ramp 222R,

The ramps 222, 222C, 222R (both on and off ramps) may be “closed” temporarily from general access by the autonomous guided goods bots 262 (e.g., only predetermined autonomous guided goods bots delivering breakpack goods to and from the breakpack goods interface locations 263L within the areas designated by the ramps 222, 222C, 222R have access to respective on and off ramps). Generally the ramps 222, 222C, 222R provide passage to and from a passing lane to a destination breakpack goods interface location 263L. Each ramp 222, 222C, 222R may be bidirectional (such as where a goods bot 2662 enters the ramp and travels in one direction along the ramp to pick or place a breakpack good BPG and then travels in the opposite direction along the ramp to exit from the ramp). The ramp may be a “counter-flow ramp” where travel along a ramp 222, 222C, 222R is in a generally opposing direction to a travel direction around one or more of the travel loop(s) 234 (e.g., an autonomous guided goods bot 262 exits the travel loop and travels in the generally opposing direction along the ramp 222, 222C, 222R). Where the ramp 222, 222C, 222R is an off ramp, the ramp 222, 222C, 222R may terminate at the destination breakpack goods interface location 263L. Similarly, where the ramp 222, 222C, 222R is an on ramp, the ramp 222, 222C, 222R may begin at the destination breakpack goods interface location 263L. As noted above, the ramps 222, 222C, 222R may be located anywhere on the goods transfer deck 130DG such that ramp entry locations vary in what may be referred to as a parking lane (e.g., a lane or a portion of a travel loop in which the goods bot stops to pick or place breakpack goods BPG) based on one or more of bot kinematics and locations of available breakpack goods interface locations 263L. It is noted that while the turns of the autonomous guided goods bots 262 to and from the ramps 222, 222C, 222R are illustrated as being substantially 90° turns, in other aspects, the turns may have an “S” shape similar to that described in U.S. patent application Ser. No. 16/144,668 filed on Sep. 27, 2018 and titled “Storage and Retrieval System”, the disclosure of which is incorporated herein by reference in its entirety.

The ramps 222, 222C, 222R are dynamically generated and may be dynamically effected (e.g., a “rolling” ramp, such as ramp 222R) so that the ramp “rolls” in a progressive fashion with an initial ramp length generated from goods bot entry with adequate clearance for goods bot collision avoidance. In one or more aspects, the ramp 222, 222C 222R is initiated (at bot entry) given that the ramp to the destination breakpack goods interface location 263L is “blocked” (or otherwise obstructed) by an active autonomous guided goods bot 262/active breakpack goods interface location 263L but the blockage is expected to clear before the autonomous guided goods bot 262 traveling along the ramp reaches the blockage. If the blockage to the ramp 222, 222C, 222R clears, the ramp 222, 222C, 222R may be extended to the destination breakpack goods interface location 263L; however, if the blockage does not clear the autonomous guided goods bot 262 travelling along the ramp 222, 222C, 222R may be redirected to, for example, a passing lane and a new ramp is calculated/determined so that the autonomous guided goods bot 262 can place breakpack goods BPG at the destination breakpack goods interface location 263L or another destination breakpack goods interface location 263L.

Referring also to FIG. 2D, the breakpack operation station 140 is configured so that one or more breakpack goods BPG are unpacked from supply container(s) 265 at the breakpack operation station 140, and at least one autonomous guided goods bot 262 is configured so as to be loaded with the one or more breakpack goods BPG at the breakpack operation station 140. An operator at the breakpack operation station 140 may place the breakpack goods BPG to the at least one autonomous guided goods bot 262 for transfer to the breakpack goods interface 263. Referring to FIGS. 1 and 2A, a belt sorter BST may be disposed between the breakpack operation station 140 and the autonomous guided goods bots 262 and forms an interface therebetween. Here the operator at the breakpack operation station places the breakpack goods BPG to the belt sorter BST where the belt sorter BST sorts (and in some aspects operates as a sorting buffer) the breakpack goods BPG to the autonomous guided goods bots 262. The breakpack operation station 140 includes any suitable supply container 265 support surface 140S. The support surface 140S may be an undeterministic surface substantially similar to that of the storage shelves described herein and include slats 1210S that form the support surface 140S. The support surface 140S may be an undeterministic roller conveyor (powered or unpowered), having rollers 140RL with an arrangement similar to rollers 110RL (see FIGS. 4A and 4B) of the container bot 110 described herein so that tines 273A-273E of the pick head 270 of the container bot 110 (FIGS. 4A and 4B) are interdigitated with the rollers of the roller conveyor for placing (or picking) supply containers 265 to (or from) the support surface 140S. Here, the container bot 110 is configured to autonomously transfer the supply container(s) 265 from the container bot 110 to the breakpack operation station 140 (such as to the support surface 140S) in the manner described herein. Referring to FIGS. 1 and 2A, the autonomous guided container bots 110 may deliver the supply containers 265 to a belt sorter BST configured as an interface between the autonomous guided container bots 110 and the breakpack operation station 140. Here, the autonomous guided container bots 110 place the supply containers 265 to the belt sorter BST and the belt sorter BST sorts the supply containers 265 (and in some aspects operates as a sorting buffer) to the support surface 140S of the breakpack operation station 140. The support surface 140S may be configured so that as the supply containers 265 are placed by the container bot 110 or belt sorter BST the supply containers 265 move along the support surface 140S towards an operator 141 (e.g., a human operator or any suitable robotic operator (e.g., articulated arm, gantry, etc.)) for picking of breakpack goods BPG from the supply containers 265 and placement of the picked breakpack goods to autonomous guided goods bots 262 or to one or more of standardized containers 265S (such as totes, trays, etc.) and breakpack goods containers 264 located at an operator staging area 140A in any suitable manner to effect one or more of a pack level sortation of goods or a unit/each level sortation of goods. The supply containers 265 may be moved along the support surface 140S to a respective operator staging area 140A where the operator 141 picks the breakpack goods BPG from the supply containers 265 for placement in an autonomous guided goods bot 262 or in another container 265S, 264. The operator staging area 140A may be contiguous with and/or formed by the support surface 140S. As described herein, supply cases 265 with remaining goods therein after breakpack is performed may be picked by the autonomous guided container bots 110 from the support surface 140S or staging area 140A and returned to storage or to a lift 150. Empty supply containers 265 may be removed from the support surface 140S or staging area 140A by the operator 141 and stored at the breakpack operation station 140 for later removal in any suitable manner. In one or more aspects, autonomous guided container bots 110 may transport empty containers from the storage and retrieval system via the lifts 150. The breakpack operation station 140 may include any suitable refuse removal system 223 for removing refuse (or trash, e.g., shrink wrapping, packaging, boxes, etc.) from the storage and retrieval system. The refuse removal system 223 may include one or more of chutes, conveyors, lifts, or any other suitable transport configured to move refuse to a predetermined location; while in other aspects, the refuse may be placed in containers and removed from the storage and retrieval system by the autonomous guided container bots 110 via the lifts 150. As can be seen in FIGS. 2C and 13, the breakpack goods transfer deck 130DG joins the breakpack operation station 140 and the container transfer deck 130DC at a separate location (e.g., at the breakpack goods interface locations 263L) from each access of the container transfer deck 130DC to the breakpack operation station 140 (e.g., at the common support surface 140S) for the container bot 110.

The autonomous guided container bots 110 may be any suitable independently operable autonomous transport vehicles that carry and transfer case units along the X and Y throughput axes throughout the storage and retrieval system 100. The autonomous guided container bots 110 may be automated, independent (e.g. free riding) autonomous transport vehicles. Suitable examples of bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2015; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The autonomous guided container bots 110 (described in greater detail below) may be configured to place case units, such as the above described retail merchandise, into picking stock in the one or more levels of the storage structure 130 and then selectively retrieve ordered case units. The throughput axes X and Y (e.g. pickface transport axes) of the storage array may be defined by the picking aisles 130A, at least one container transfer deck 130DC, the container bot 110 and the extendable end effector (as described herein) of the container bot 110 (and in other aspects the extendable end effector of the lifts 150 also, at least in part, defines the Y throughput axis).

The pickfaces (which may include supply containers 265) are transported between an inbound section of the storage and retrieval system 100, where pickfaces inbound to the array are generated (such as, for example, input station 160IN) and a load fill section of the storage and retrieval system 100 (such as for example, output station 160UT or output station 160EC), where outbound pickfaces from the array are arranged to fill a load in accordance with a predetermined load fill order sequence or an individual fulfillment order(s) in accordance with a predetermined individual fulfillment order sequence. Pickfaces (e.g., of supply containers 265) may be transported between the storage spaces 130S and a load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence. Breakpack goods container(s) 264 (which may be multiple breakpack goods containers may be arranged in and transported as a pickface) may be transported between the storage spaces 130S and the load fill section and/or between the breakpack goods interface 263 of the breakpack module(s) 266 and the load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence.

Referring also to FIGS. 1A, 1B, 1C, and 2A the rack module array RMA (see FIGS. 1C and 2A) of the storage structure 130 includes vertical support members 1212 and horizontal support members 1200 (see FIGS. 1A and 1B) that define the high density automated storage array as will be described in greater detail below. Rails 1200S may be mounted to one or more of the vertical and horizontal support members 1212, 1200 in, for example, picking aisles 130A and be configured so that the autonomous guided container bots 110 ride along the rails 1200S through the picking aisles 130A. At least one side of at least one of the picking aisles 130A of at least one storage level 130L may have one or more storage shelves (e.g. formed by rails 1210, 1200 and slats 1210S).

Autonomous guided container bots 110 traversing a picking aisle 130A, at a corresponding storage level 130L, have access (e.g. for picking and placing case units and/or breakpack goods containers) to each storage space 130S that is available on each shelf, where each shelf (which shelves may be disposed on one or more storage levels located between adjacent vertically stacked storage levels 130L on one or more side(s) PAS1, PAS2 of the picking aisle 130A). Each storage space 130S of the one or more storage shelf levels is accessible by the container bot 110 from the rails 1200 (e.g. from a common picking aisle deck 1200S that corresponds with a container transfer deck 130DC on a respective storage level 130L).

Referring again to FIG. 2A each container transfer deck 130DC or storage level 130L may include one or more lift pickface interface/handoff stations TS (referred to herein as interface stations TS) where case unit(s) (e.g. individual case units, pickfaces, supply containers, etc.), totes and/or breakpack goods containers 264 are transferred between the lift load handling devices LHD and autonomous guided container bots 110 on the container transfer deck 130DC. The interface stations TS are located at a side of the container transfer deck 130DC opposite the picking aisles 130A and rack modules RM, so that the container transfer deck 130DC is interposed between the picking aisles and each interface station TS. As noted above, each container bot 110 on each picking level 130L has access (via a respective container transfer deck 130DC) to each storage location 130S, each picking aisle 130A, and each lift 150 on the respective storage level 130L, as such each container bot 110 also has access to each interface station TS on the respective level 130L. The interface stations TS may be offset from high-speed bot travel paths HSTP along the container transfer deck 130DC so that container bot 110 access to the interface stations TS is undeterministic to bot speed on the high speed travel paths HSTP. As such, each container bot 110 can move a case unit(s) (e.g. individual case units, pickfaces (built by the bot), supply containers, etc.), totes and/or breakpack goods containers 264 from every interface station TS to every storage space 130S corresponding to the deck level 130L and vice versa.

The interface stations TS may be configured for a passive transfer (e.g. handoff) of case units (e.g. individual case units, pickfaces, supply containers, etc.), totes and/or breakpack goods containers 264 between the container bot 110 and the load handing devices LHD of the lifts 150 (e.g. the interface stations TS have no moving parts for transporting the case units) which will be described in greater detail below. For example, also referring to FIG. 2B the interface stations TS and/or buffer stations BS include one or more stacked levels TL1, TL2 of transfer rack shelves RTS (e.g. the container bot 110 being configured to access each of the one or more stacked levels TL1, TL2) which in one aspect are substantially similar to the storage shelves described above (e.g. each being formed by rails 1210, 1200 and slats 1210S) such that container bot 110 handoff (e.g. pick and place) occurs in a passive manner substantially similar to that between the container bot 110 and the storage spaces 130S (as described herein) where the case units or totes are transferred to and from the shelves. The buffer stations BS on one or more of the stacked levels TL1, TL2 may serve as a handoff/interface station with respect to the load handling device LHD of the lift 150. Load handling device LHD (or lift) may handoff (e.g. pick and place) of case units (e.g. individual case units, pickfaces, supply containers, etc.), totes and/or breakpack goods containers 264 to the stacked rack shelves RTS (and/or the single level rack shelves) occurs in a passive manner substantially similar to that between the container bot 110 and the storage spaces 130S (as described herein) where the case units, totes and/or breakpack goods containers 264 are transferred to and from the shelves. The shelves may include any suitable transfer arms for picking and placing case units, totes and/or breakpack goods containers 264 from one or more of the container bot 110 and load handling device LHD of the lift 150. Suitable examples of an interface station with an active transfer arm are described in, for example, U.S. Pat. No. 9,694,975 issued on Jul. 4, 2017, the disclosure of which is incorporated by reference herein in its entirety.

The location of the container bot 110 relative to the interface stations TS may occur in a manner substantially similar to bot location relative to the storage spaces 130S. For example, location of the container bot 110 relative to the storage spaces 130S and the interface stations TS may occur in a manner substantially similar to that described in U.S. Pat. No. 9,008,884 issued on Apr. 14, 2015 and U.S. Pat. No. 8,954,188 issued on Feb. 10, 2015, the disclosures of which are incorporated herein by reference in their entireties. For example, referring to FIGS. 1 and 1A, the container bot 110 includes one or more sensors 110S that detect the slats 1210S or a locating feature 130F (such as an aperture, reflective surface, RFID tag, etc.) disposed on/in the rail 1200. The Slats and/or locating features 130F are arranged so as to identify a location of the container bot 110 within the storage and retrieval system, relative to e.g. the storages spaces and/or interface stations TS. The container bot 110 may include a controller 110C that, for example, counts the slats 1210S to at least in part determine a location of the container bot 110 within the storage and retrieval system 100. The location features 130F may be arranged so as to form an absolute or incremental encoder which when detected by the container bot 110 provides for a container bot 110 location determination within the storage and retrieval system 100. The sensor 110S may be configured to localize the container bot 110 through any suitable image processing of images of case units disposed on the storage selves.

One or more peripheral buffer/handoff stations BS (substantially similar to the interface stations TS and referred to herein as buffer stations BS) may be located at the side of the container transfer deck 130DC opposite the picking aisles 130A and rack modules RM, so that the container transfer deck 130DC is interposed between the picking aisles and each buffer station BS. The peripheral buffer stations BS may be interspersed between or, as shown in FIGS. 2A and 2B, otherwise in line with the interface stations TS. The peripheral buffer stations BS may be formed by rails 1210, 1200 and slats 1210S and may be a continuation of (but a separate section of) the interface stations TS (e.g. the interface stations and the peripheral buffer stations are formed by common rails 1210, 1200). As such, the peripheral buffer stations BS may include one or more stacked levels TL1, TL2 of transfer rack shelves RTS as described above with respect to the interface stations TS, although the buffer stations may include a single level of transfer rack shelves. The peripheral buffer stations BS define buffers where case units/totes/breakpack goods containers and/or pickfaces are temporarily stored when being transferred from one container bot 110 to another different container bot 110 on the same storage level 130L as will be described in greater detail below. The peripheral buffer stations may be located at any suitable location of the storage and retrieval system including within the picking aisles 130A and anywhere along the container transfer deck 130DC.

Still referring to FIGS. 2A and 2B, at least the interface stations TS may be located on an extension portion or pier 130BW (also referred to as a driveway) that extends from the container transfer deck 130DC, although a length of the interface stations TS may be arranged and extend along the container transfer deck. The pier 130BW may be similar to the picking aisles where the container bot 110 travels along rails 1200S affixed to horizontal support members 1200 (in a manner substantially similar to that described above). The travel surface of the pier 130BW may be substantially similar to that of the container transfer deck 130DC. Each pier 130BW is located at the side of the container transfer deck 130DC, such as a side that is opposite the picking aisles 130A and rack modules RM, so that the container transfer deck 130DC is interposed between the picking aisles and each pier 130BW. The pier(s) 130BW extends from the transfer deck at a non-zero angle relative to at least a portion of the high speed bot transport path HSTP. The pier(s) 130BW may extend from any suitable portion of the container transfer deck 130DC including the ends 130BE1, 130BE2 of the container transfer deck 130DCD. Peripheral buffer stations BSD (substantially similar to peripheral buffers stations BS described above) may be located at least along a portion of the pier 130BW.

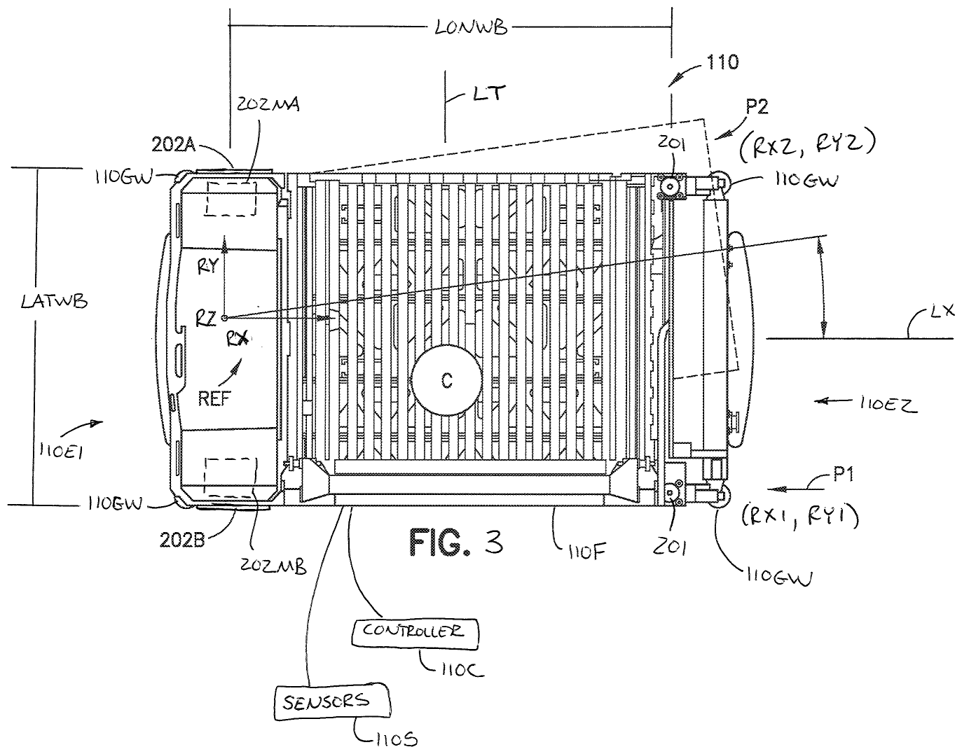

As described above, and referring to FIG. 3, the autonomous guided container bots 110 and the autonomous guided goods bots 262 may be non-holonomic. For example, referring to the container bot 110 for exemplary purposes (noting the autonomous guided goods bots 262 have a similar non-holonomic configuration), the goods bot 110 includes two drive wheels 202A, 202B located on opposite sides of the bot 110 at end 110E1 (e.g. first longitudinal end) of the bot 110 for supporting the bot 110 on a suitable drive surface however, in other aspects any suitable number of drive wheels are provided on the bot 110. Each drive wheel 202A, 202B may be coupled substantially directly to a respective motor 202MA, 202MB such that the drive wheel 202A, 202B is coupled to an output of the motor 202MA, 202MB without a speed reduction unit disposed therebetween (e.g. so that each motor 202MA, 202MB and the respective drive wheel 202A, 202B form a reductionless drive). Each drive wheel 202A, 202B may be independently controlled so that the bot 110 may be steered through a differential rotation of the drive wheels 202A, 202B (e.g. differential torque steering), although the rotation of the drive wheels 202 may be coupled so as to rotate at substantially the same speed. Any suitable steering wheels 201 are mounted to the frame on opposite sides of the bot 110 at end 110E2 (e.g. second longitudinal end) of the bot 110 for supporting the bot 110 on the drive surface. The wheels 201 may be caster wheels that freely rotate allowing the bot 110 to pivot through differential rotation of the drive wheels 202 for non-holonomically changing a travel direction of the bot 110. The wheels 201 may be steerable wheels, such as for example articulated wheel steering, that turn under control of, for example, a bot controller 110C (which is configured to effect control of the bot 110 as described herein) for changing a travel direction of the bot 110. The bot 110 may include any suitable wheel arrangement (e.g. a three wheel configuration, a four wheel configuration, etc.). The bot 110 may include one or more guide wheels 110GW located at, for example, one or more corners of the frame 110F. The guide wheels 110GW may interface with the storage structure 130, such as guide rails 1200 (FIG. 1B) within the picking aisles 130A, guide rails (not shown) on the transfer deck 130B and/or at interface or transfer stations for interfacing with the lift modules 150 for guiding the bot 110 and/or positioning the bot 110 a predetermined distance from a location to/from which one or more case units are placed and/or picked up as described in, for example, U.S. Pat. No. 9,561,905 issued on Feb. 7, 2017, the disclosure of which is incorporated herein by reference in its entirety. Location of the bot 110 at the predetermined distance from a location to/from which one or more case units are placed and/or picked up may be effected in any suitable manner such as with sonar/sonic sensors, index or line following sensor, GPS sensors, inductive sensors, capacitive sensors, infrared sensors, computer vision sensors, etc. of the container bot 110 or any combination thereof.

As described herein, and referring to FIG. 4, the container transfer deck 130DC may have an undeterministic transport surface 130BS on which the autonomous guided container bots 110 travel where the undeterministic transport surface 130BS has more than one juxtaposed travel direction or lane HSTP (which correspond at least in part to a guidance feature of navigation array 3000 that is disposed on the undeterministic transport surface 130BS) connecting the aisles 130A, transfer deck 130B, and the pier 130BW to each other. While the navigation array is described herein with respect to the container transfer deck 130DC, it is noted the breakpack goods transfer deck 130DG may be similar to the container transfer deck 130DC and include a respective navigation array 3000 having the features described herein with respect to the container transfer deck 130DC. The juxtaposed travel lanes (the terms “travel lane” and “direction” may be used interchangeably herein) are juxtaposed along a common undeterministic transport surface 130BS between opposing sides 130BD1, 130BD2 (see also FIG. 2A) of the transfer deck 130B. For example, FIG. 4 illustrates longitudinal lanes such as an aisle side travel lane LONG1, a lift side travel lane LONG3 and a pass through travel lane LONG2, but it should be understood that in other aspects more or fewer travel lanes are provided. Juxtaposed lateral travel lanes, such as lanes LAT1-LAT7 may be arranged on the transfer deck 130B to allow bot traverse to and from picking aisles 130A, driveways 130BW, transfer stations TS, buffer stations BS, and/or any other suitable location of the storage and retrieval system that is accessed through a path that is transverse to the longitudinal lanes.

As can be seen in FIG. 4 the navigation array 3000 is illustrated, for exemplary purposes, as a grid of linearly distributed features. The linearly distributed features LDF may include longitudinal features LONG1-LONG3 and lateral features LAT1-LAT7 where the longitudinal and lateral directions are relative to the transfer deck (e.g. the longitudinal features LONG1-LONG3 define at least one of the travel lanes HSTP and the lateral features LAT1-LAT7 define travel lanes HSTT that cross the travel lanes HSTP. The linearly distributed features LDF may allow for container bot 110 traverse between offset (parallel and/or crossing) travel lanes HSTP, HSTT in the storage structure 130 for entry into aisles 130A, driveways 130BW, buffer stations BS, transfer stations TS or any other suitable location at which the bot 110 performs an operation (transfer of cases, charging of the bot, bot induction into the storage structure, bot removal from the storage structure, etc.). The linearly distributed features LDF may allow for bot traverse between crossing travel lanes HSTP, HSTT for entry into aisles 130A, piers 130BW, buffer stations BS, transfer stations TS or any other suitable location at which the bot 110 performs an operation (transfer of cases, charging of the bot, bot induction into the storage structure, bot removal from the storage structure, etc.) where when the bot 110 detects a linear distributed feature the bot 110 establishes a location of the bot 110 during travel as will be described in greater detail below. One or more of the aisles 130A and piers 130BW may be “dead ends” in that there is an entry into the aisle 130A or pier 130BW from the container transfer deck 130DC but there is no exit for the container bot from the aisle 130A or pier 130BW unless the container bot reverses direction and exits the aisle 130A or pier 130BW at the same point the bot entered the aisle 130A or pier 130BW (i.e., the aisle or pier has restricted access such that only a single point of ingress/egress to/from the aisle or pier exists).

The linearly distributed features LDF may connect the aisles 130A to each other, cross the aisles 130A, connect the aisles 130A to one or more of the transfer stations TS, the buffer stations BS and the piers 130BW or any combination thereof. One or more of the linearly distributed features LDF may be substantially aligned with one or more of the interface between the transfer deck 130B and the aisles 130A, and the interface between the transfer deck 130B and the piers 130BW. As noted above, at least a portion of the linearly distributed features LDF may be substantially aligned with one or more bot traverse paths 3010 along the transfer deck 130B. It is noted that while the linearly distributed features LONG1-LONG3, LAT1-LAT7 are illustrated as forming an orthogonal grid in other aspects the longitudinal features LONG1-LONG3 and the lateral features LAT1-LAT7 cross each other at any suitable angles. While three longitudinal features LONG1-LONG3 (defining, for example, at least in part three travel lanes HSTP) and seven lateral features LAT1-LAT7 (defining, for example, at least in part seven travel lanes HSTT) are described, the transfer deck 130B may include any suitable number of longitudinal and lateral features LONG1-LONG3, LAT1-LAT7 defining at least in part any suitable number of travel lanes oriented in any suitable directions relative to the transfer deck 130B.

The linearly distributed features LDF may be formed of, for example, any suitable guide tapes, any suitable transfer deck 130B features (grooves, apertures, channels, etc.), and edge of the transfer deck 130B or any combination thereof. The linearly distributed features LDF may be uncoded (e.g. do not include identifying features such as for determining container bot 110 location) while in other aspects the linearly distributed features are coded (e.g. include or are formed of barcodes or other identifying indicia or features so as to provide for container bot 110 location determination). It is noted however, that the linearly distributed features may be placed at predetermined locations on the transfer deck 130B to allow the bot to establish at least an estimated location of the container bot 110 while travelling at high speeds (as previously described) along the transfer deck 130B. With reference to FIG. 3, the spacing between juxtaposed linearly distributed features LDF is not dependent on container bot 110 dimensions or operational aspects, such as bot longitudinal wheelbase LONWB (where the container bot 110 has a longitudinal axis LX and a lateral axis LT), wheel track or lateral wheelbase LATWB, turn radius and bot width (in the lateral direction). The bot frame 110F, longitudinal wheelbase LONWB and lateral wheelbase LATWB may define a predetermined aspect (such as for example, a ratio of length to width) that provides the non-holonomic container bot 110 with a minimum turn radius (and/or minimum turn radius footprint defined by the outermost corners of the frame turning at the minimum turn radius). The spacing between juxtaposed travel lanes LONG1-LONG3, LAT1-LAT7 may be such that it allows passage of two autonomous guided container bots 110 (travelling linearly) side by side on each lane but is less than the minimum turn radius of the non-holonomic container bot 110 for a 90° pivot turn (pivoting at the drive wheels 202—see FIG. 3, such as at a pivot location/axis disposed between the drive wheels 202A, 202B)). As such the outer lanes (e.g. the aisle side travel lane and the lift side travel lane and/or corresponding lanes at the ends 130BE1, 130BE2 of the container transfer deck 130DC) are, in one aspect positioned close to the sides of the container transfer deck 130DC (by an amount just sufficient to allow the container bots 110 to travel along the travel lane) but less than the spacing required for the container bot 110 to make a 90° pivot turn (pivoting at the drive wheels 202—see FIG. 3). The position of the picking aisles 130A, the lift interfaces/transfer stations TS and buffers stations BS relative to the container transfer deck 130DC and each other are decoupled from bot 110 turn considerations.

It is noted that for descriptive purposes only, the intersections between the linearly distributed features are referred to as nodes ND so that the transfer deck surface 130BS and its associated features (e.g. the linearly disturbed features LDF) are represented as a grid (as described above) with an array of nodes. The nodes ND may be disposed at any suitable predetermined location on the longitudinal and/or lateral features LONG1-LONG3, LAT1-LAT7 (such as at an intersection) of the linearly distributed features LDF that may correspond, for example, to a feature of the storage structure 130 and/or navigation array 3000 (e.g. at a terminus to a storage aisle 130A, at a lift transfer station TS, an entry to a pier 130BW, at a buffer station BS or at any other suitable location of the container transfer deck 130DC). It should be understood that the concept of a node ND as used herein is to exemplify that the navigation array 3000 defines the linearly distributed features LDF which map out the container transfer deck 130DC in two dimensions where the array of nodes ND on the deck are associated with the longitudinal and lateral features LONG1-LONG3, LAT1-LAT7. As will be described in greater detail below, waypoints WP1-WP2 that lay along a container bot 110 travel path may be created at predetermined locations on the container transfer deck 130DC where in some aspects one or more waypoints WP1-WP4 may coincide with one or more nodes ND and, as with the nodes ND, may be positioned on linearly distributed features LDF defining a respective linear direction. One or more of the waypoints WP1-WP4 may be located between nodes ND, be located offset from the nodes ND in any suitable direction, or be located offset from the linearly distributed features LDF in any suitable direction.

As described herein, the container bots 110 travel along time optimal paths and trajectories, examples of which are illustrated in FIG. 4 with respect to transport paths BTP-BTP3 where each of the transport paths embody respective trajectories. The transport path BTP includes waypoints WP1, WP2, WP3, and WP4. The transport path BTP2 includes waypoints WP5 and WP6. The transport path BPT3 includes waypoints WP6 and WP7. The transport paths may include straight paths, arcuate paths, compound paths forming shapes such as “S” shape curves, or any other combination of straight and arcuate paths. The time optimal paths and trajectories may be generated in any suitable manner such as the manner described in U.S. Pat. No. 11,760,570 issued on Sep. 19, 2023 the disclosure of which is incorporated herein by reference in its entirety. The time-optimal trajectories 990A-990n, 991A-991n, 992A-992n, 993A-993n, 994A-994n and respective time optimal paths embodied thereby allow the bot 110 to smoothly transition, while travelling at the high speeds described herein, along a smooth curved (curve, curves, or curvature is used generally herein to refer to traverse path lines with concave/convex shape, through the techniques applied herein are equally applicable to path lines with flat curves that will be expressly identified as such) path defined by the corresponding trajectory between two navigation features arranged along a common direction (e.g. such as between one or more of the longitudinal navigation features LONG1-LONG3 or between one or more of the lateral navigation features LAT1-LAT7) and/or between two navigation features that are arranged in different directions (e.g. such as between longitudinal navigation features LONG1-LONG3 and lateral navigation features LAT1-LAT7, see FIG. 4). The time-optimal trajectories 990A-990n, 991A-991n, 992A-992n, 993A-993n, 994A-994n, based on bot dynamic model(s), may be categorized or catalogued, in a table 6042T (such as stored in a memory 110M, 262M of the bot controller 110C, 262C of a respective autonomous guided container bot 110 and/or autonomous guided goods bot 262—see FIG. 4A), in any suitable manner. The trajectories are according to their respective characteristics shown categorized according to linear length L, L1, . . . , Ln along the curved path defined by the corresponding trajectory where the length L, L1, . . . , Ln may correspond to a linear distance to be travelled by the bot 110 between positions P1 (RX1, RY1) and P2 (RX2, RY2) (see FIGS. 3 and 4) defined within the bot 110 map coordinate system REF as specified in a bot motion command received from, for example, controller 120.

Referring now to FIGS. 4, 5A, and 5B, exemplary bot traverse paths of an exemplary container bot 110 are shown in accordance with the present disclosure. These transport paths may be for any suitable bot such as, for example, the container bots 110 and/or autonomous guided goods bots 262 described herein. The time-optimal trajectory or trajectories may be generated (in any suitable manner, such as described in U.S. Pat. No. 11,760,570, previously incorporated herein by reference in its entirety) for each of these exemplary traverse paths. It is noted that the term “traverse path” as used herein and depicted in the drawings refers to the physical traverse paths of the autonomous guided container bots 110 and/or autonomous guided goods bots 262 on/along the undeterministic surface 130BS defined by the open undeterministic container transfer deck 130DC (and similar undeterministic surface defined by the open and undeterministic goods deck 130DG) or floor between locations thereon. It is noted that the traverse paths may include one or more segments (such as those described herein with respect to FIGS. 4 and 4A) that are joined to each other to form the traverse path. The term “trajectory” of the traverse path includes kinematic properties of the respective autonomous guided container bot 110 and autonomous guided goods bot 262 such as, for example, acceleration, velocity, etc. moving along and defining the traverse path.

As described above, any suitable controller, such as controller 110C, 262C of the respective autonomous guided container bot 110 and autonomous guided goods bot 262, may be configured as a bang-bang controller for generating time-optimal motions of the bot 110 using maximum power of the respective autonomous guided container bot 110 and autonomous guided goods bot 262 drive section. It is noted the present disclosure allows for the generation of otherwise predetermined autonomous guided bot 110, 262 unparameterized autonomous guided bot 110, 262 trajectories having motor torque (e.g. maximum torque/peak usable torque) and/or boundary constraints for, e.g., different autonomous guided bot 110, 262 payload applications or any other velocity, acceleration, etc. constraints. The term unparameterized as used herein with respect to the generated trajectories means that the trajectory and traverse path characteristics are unconstrained as to the curve or shape of the trajectory (either with respect to time or in the position-velocity reference frame or space) such that a time-optimal trajectory shape is achieved within the noted constraints of available autonomous guided bot 110, 262 maximum motor torque (e.g., the desired maximum usable torque for the maximum available current from the autonomous guided bot 110, 262 power source, and other bot dynamic models (e.g., mass, moment of inertia, radius of drive wheels, drive wheel base, etc.) and initial and final inertial conditions). Trajectories can be generated for each of the traverse path segments such that optimal (shortest) move times (e.g. autonomous guided bot 110, 262 traverse times between a starting point of the traverse path and an ending point of the traverse path) are achieved for given maximum drive torque constraints. Further, peak torque requirements for drive components, such as motors and/or gear boxes (if any), can be reduced (with or without shorter move times) leading to lower costs associated with the autonomous guided bot 110, 262, reduced size of the drive components, and/or increased life of the autonomous guided bot 110, 262.

As used herein, the term “smooth” or “smoothness” with respect to the generated trajectories refers to a continuous linear velocity along the curved traverse path over time. It is noted that a discontinuity in linear velocity is generally not practically achievable, given the autonomous guided bot 110, 262 inertial and dynamic characteristics at high and medium speeds, and undesired.

The time-optimal trajectories may be categorized based on autonomous guided bot 110, 262 dynamic model characteristics and/or other boundary conditions, such as a bot payload (e.g., empty or loaded bot), payload mass and/or size where more massive payloads and/or denser payloads (e.g., resulting in bot mass center eccentricity) may define larger radius/curved turns at the high speeds. The trajectories may be categorized based on one or more of a distance to be travelled by the autonomous guided bot 110, 262 and a payload weight/mass and/or size/mass distribution or payload density.

As may be realized from FIGS. 4 and 4A, there are different types of predetermined time-optimal dynamic model based trajectories that define different path curves the autonomous guided bot 110, 262 can dynamically select by the bot controller 110C, 262C (or any other suitable controller such as control server 120 or warehouse management system 2500) from, singly and/or in a dynamically selected combination applied consecutively or separated by a flat path line (see FIG. 4A), to follow from an initial position (with an initial static and/or on the fly pose) to a final position (with a final desired/resultant static and/or on the fly pose). The trajectories may be characterized by simple curves having any suitable shape such as a straight line, semi-circles and hook or “J” shapes while in other aspects the trajectories are any suitable complex curves such as “S” shaped curves having multiple changes in direction or inflection points as described. For example, one type of time-optimal trajectory is a component time-optimal trajectory having curved portions and straight portions where the curved portions are compound curves or turns with one or more of a variable or constant turn radius/rate, constant or changing turn directions and simple turns. As another example of a time-optimal trajectory type, the characterizing path shapes of the time optimal trajectories are a simple turn (turning in one direction during the move) having one or more of a variable turn radius/rate (e.g., the trajectory of paths 991A-991n and 992A-992n illustrated in FIG. 4A) or constant turn radius/rate (e.g., the trajectory of paths 990A-990n illustrated in FIG. 4A) in a single direction. The different component time-optimal trajectories (e.g. simple and compound) may be joined to each other, end to end, to form a transport path BTP (e.g., as shown in FIG. 4, having a time-optimal trajectory characterized by an “S” shape (e.g., such as the trajectory of paths 993A-993n shown in FIG. 4A) combined with a time-optimal trajectory characterized by a simple curve/turn; although a flat curve path trajectory (e.g., such as the trajectory of paths 994A-994n shown in FIG. 4A) may be joining the bending curve path trajectory) followed by the autonomous guided bot 110, 262.

Referring now to FIGS. 4, 4A, 5A and 5B, conventionally non-holonomic autonomous guided bot 110 traverse across the container transfer deck 130DC or a goods deck 130DG is facilitated by, for example (see FIG. 5A) line following where the guidelines are arranged in a grid pattern such that bot (autonomous guided vehicle) turns are limited to 90° turns where the 90° turns are made at nodes ND (e.g. crossing points) of the guidelines. As may be realized from the above, the high speed navigation of the autonomous guided bots 110, 262 described herein allows substantially unrestricted non-holonomic autonomous guided bot 110, 262 traverse (see FIG. 5B) along the undeterministic surface of a respective one of the open undeterministic container transfer deck 130DC and the open undeterministic breakpack goods transfer deck 130DG such the bot 110, 262 can travel from node to node without being restricted to making 90° turns at the nodes ND, thereby decreasing autonomous guided bot 110, 262 transfer/travel times across the respective container transfer deck 130DC and breakpack goods transfer deck 130DG. This allows the autonomous guided bot 110, 262 to travel at the speeds described herein while navigating the undeterministic surface of the respective container transfer deck 130DC and breakpack goods transfer deck 130DG and while making turns into the picking aisles 130A and/or lift interface areas such as the driveways 130BW or buffer/transfer stations located along a side of the container transfer deck 130DC (such as shown in FIGS. 2A-2C) or to breakpack stations 140 and breakpack goods interface location(s) 263L of a breakpack goods interface 263 of the breakpack goods transfer deck 130DG.

Referring to FIGS. 1 and 6A, as described herein, autonomous guided bot 110, 262 route planning may be effected by one or more of the controller 120 and warehouse management system 2500 (or any other suitable controller of the storage and retrieval system 100). Bot route planning will be described with respect to controller 120 for exemplary purposes only, where bot route planning may be effected in a similar manner when performed by the resolver 2500PR of the bot route planner 2500P of the warehouse management system 2500.

As described herein, the controller 120 includes the resolver 120PR that is configured with the bot route planner 120P. The bot route planner 120P is configured to obtain or otherwise collect unplanned route legs URL and effect planning of the bot routes based on bot priority. Here, the resolver 120PR divides or otherwise sequences the unplanned route legs URL into batches BRL. An example for determining a of batch route legs will now be described, where the bath of route legs BRL meets the predetermined maximum number N of route legs.

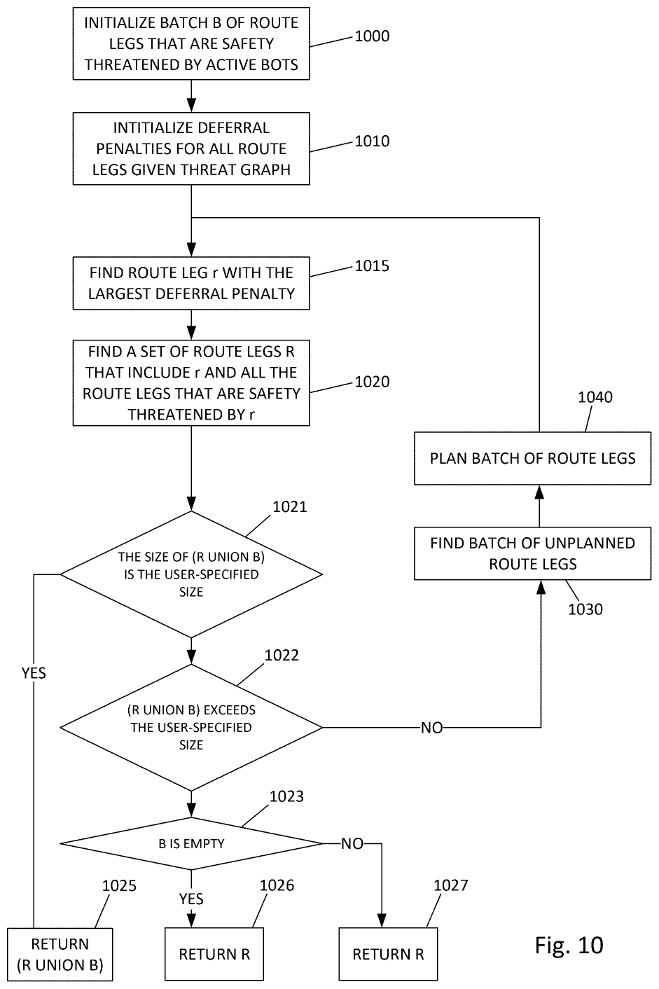

In determining a batch, the resolver 120PR initializes a batch B. If this batch B is the first batch, the batch B is initialized (FIG. 10, Block 1000) to be the route legs that are recursively safety-threatened by active route legs; otherwise, the batch BRL is initialized to be an empty set.

With respect to batching of route legs, decisions made by the resolver 120PR for batching or otherwise grouping route legs are defined. Given a batch size limit (i.e., the predetermined maximum number N of route legs), a batching decision BRL of a set of route legs is a sequence BRLS of batches BRL1-BRLn that exactly cover all the route legs, and each batch BRL1-BRLn does not exceed the predetermined maximum number N of route legs in a batch. A partial batching decision PB is also defined as a batching decision of a subset of given route legs. All the batching decisions that can be extended from a partial batching decision PB for un selected route leg set R is defined as a Full Decision Set Extend (PB, R).

The batching decision obtained by adding route leg r into the current open batch of partial batch decision is defined as PB+r; and the batching decision obtained by adding route leg r into the next batch of partial batch decision is defined as PB++r.

The quality of a batching decision B is the objective value of the planning solution obtained by planning route legs batch by batch by following this batching decision. The quality of batching decision BRL is denoted as q (BRL), where objective values are maximized).

The quality of a partial batching decision PB is the maximum quality of Extend (PB, R). The it quality of a partial batching decision PB is denoted as q (PB, R)=max q (BRL) over BRL in Extend (PB, R).

The quality of batching decisions may be compared by where the priority-based divide and search autonomous transport vehicle path planning process PBDS is considered an optimal single batch scheduler, and the objective value of planning all route legs as one batch is Q*. This is the best objective value of any solution and the batching decision quality bound. Here, every batching decision's objective value is not smaller than Q*. For two batching decisions B1 and B2, we say B1 is better than B2 if q (B1)>q (B2). A good batching decision is expected to lead to a solution as close as possible to the solution obtained by directly planning all the route legs as one batch. For example, assume there are four route legs A, B, C, D and the minimized objective value is 10 by planning all of the four route legs as one batch. With a batch size limit (i.e., predetermined maximum number N of route legs in a batch) of two, if {(A, B), (C, D)} has quality 12, and {(A, C), (B, D)} has quality 15, we say the latter batching decision is better.

One example of approximating a batch determination is based on a partial batching decision PB, and unplanned route legs (r1, r2, . . . , rn). Here, deciding which route leg to select next to further extend PB, includes selecting the partial batching decision with the best quality from (PB+r1, PB+r2, . . . , PB+rn). However, it is hard to evaluate the quality of a partial batching decision PB+r, where the quality of all the decisions in Extend (PB+r, R−r) is evaluated. The number of Extend (PB+r, R−r) can grow exponentially to the number of unselected legs.

In accordance with the present disclosure, an approximation method is employed by the resolver 120PR, 2500PR to estimate impact of prioritizing a route leg r by evaluating the route leg's impact only: As g(PB, R) is a constant for every route leg selection, we evaluate g(PB, R)−g(PB+r, R−r); the effect of other unselected legs is ignored, which leads to evaluating g(PB+r)−g(PB, [r]); and as g(PB, [r])=max(g(PB+r), g(PB++r)), g(PB+r)−g(PB, [r])=max(0, g(PB+r)−g(PB++r).

This value g(PB+r)−g(PB++r) can be explained as follows: g(PB+r) is the batching decision quality of putting this leg in the current open batch; g(PB++r) is the batching decision quality of putting this leg in the next batch; and g(PB+r)−g(PB++r) is the objective value difference made by de-prioritizing leg r.

Larger the value for g(PB+r)−g(PB++r), the more urgent to put r into the current batch. This leads to a rule of route leg batching selection: pick the route leg that impacts the objective value most when being deferred into the next batch.

However, the above rule may be hard to apply in batching because in determining g(PB+r)−g(PB++r) the corresponding two objective values are determined and the difference between the two objection values are calculated. For example, putting r in the current batch or next batch may not only impact route leg r's total time to reach the destination. Here, other route legs may not get impacted a lot and another example of approximating a batch determination is based on only evaluating the impact of safety, reachability, and delay of the route leg r. The evaluation of only evaluating the impact of safety, reachability, and delay of the route leg r leads to a fundamental rule of route leg batching selection: pick the route leg that is most impacted by being deferred into the next batch.

The resolver 120PR evaluates a route leg deferral penalty (as described in greater detail herein) and initializes deferral penalties for all route legs (FIG. 10, Block 1010) given the threat graph(s) (see FIG. 7). For example, the resolver 120PR finds the route leg r with the largest deferral penalty (FIG. 10, Block 1015). The resolver 120PR finds a set of route legs R that includes the route leg r and all the route legs that are recursively safety-threatened by route legr (FIG. 10, Block 1020). The resolver 120PR adds the set of route legs R to the batch B and returns the batch B (FIG. 10, Blocks 1025, 1026, and 1027) based on the following three conditions: add and return the batch B if the batch size is the predetermined maximum number N of route legs (FIG. 10, Block 1021); if adding the set of route legs R to the batch B will exceed the predetermined maximum number N of route legs (FIG. 10, Block 1022): return the batch B if the batch B is non-empty or return the set of route legs R if the batch B is empty (FIG. 10, Block 1023); and adds but does not return the batch B if the new batch size (e.g., the sum of the set of route legs R and the batch B is smaller than the predetermined maximum number N of route legs (FIG. 10, Block 1030). The resolver 120PR updates the deferral penalties of route legs that are delayed or reachability is threatened by the route legs in the set of route legs R (FIG. 10, Block 1040). Blocks 1015-1040 of FIG. 10 may be repeated until there are no more route legs to include in a batch B.

All of the route legs that are recursively safety-threatened by one or multiple route legs are added to the batch B. This is implemented as: initializing a route leg set R with the given route legs; and repeating the following (until no route leg is added) add all the route legs that are safety-threatened or same-bot-threatened by the route legs in the current set.

The initialize deferral penalties are initialized and only a subset of the route legs' deferral penalties is updated. These are the only two steps in batching that change deferral penalties.

A batch that exceeds the batch size limit might be returned if adding the route leg set R to the batch B will exceed the predetermined maximum number N of route legs and only if the batch B is non-empty. While rare, it is possible that a route leg can recursively safety-threaten more than the predetermined maximum number N of route legs.

Referring to FIGS. 1 and 4, an example of route leg batching is illustrated with respect to autonomous guided container bots 110 travelling along one or more of the container deck 130DC, picking aisles 130A and piers 130BW. It should be understood that batching of route legs for autonomous guided goods bots 262 occurs in a same or similar manner as that of the autonomous guided container bots 110. In FIG. 4, there is an active route leg a and its subsequent dummy idling route leg A. There is an active route leg i and its subsequent dummy route leg I. There are seven other route legs B, C, D, E, F, G, H. For exemplary purposes, the predetermined maximum number N of route legs in a batch is set not to exceed three route legs.

With respect to the safety (e.g., collisions) of a bot of a given route leg, to find the first batch BRL1 of the sequence BRLS of batches BRL1-BRLn, the resolver 120PR analyzes the route legs whose safety will be threatened by active route legs (i.e., autonomous guided bots 110 of these threatened route legs may not be able to idle at the source location of the autonomous guided bots 110). If these threatened route legs are not put into the current batch BRL1, the autonomous guided bots 110 of the threatened route legs may not remain safe. For example, an autonomous guided bot of route leg B cannot be safely planned to idle at its current location since the autonomous guided bot of active route leg a is moving towards the current location of route leg B's autonomous guided bot (route leg a is a threat to route leg B). Here, route leg B may be considered as having the largest deferral penalty of the route legs unplanned route legs URL. Thus, the resolver 120PR assigns route leg B in the first batch BRL1. As route leg B may sweep by route leg D's source location and thus threats its safety as well, resolver 120PR also assigns route D (which has the next largest deferral penalty) in the current batch BRL1. As a result, the current batch BRL1 includes legs B and D.

With respect to the reachability of destination of a autonomous guided bot 110 of or belonging to a given route leg, the resolver 120PR also analyzes the route legs for blocked routes. For example, the route leg B passes to and terminates adjacent the entrance of the source aisle of route leg C. If route leg C does not get included in the current batch BRL1, an autonomous guided bot 110 of route leg B may stay disposed adjacent the entrance of the source aisle for route leg C (i.e., blocking the aisle entrance and the path of the autonomous guided bot 110 of route leg C out of the aisle). Thus, route leg C (e.g., having a next largest deferral penalty after route leg D) is prioritized to put into the current batch BRL1. As such, in this example, route legs B, C, D are assigned to the first batch BRL1 and the resolver 120PR employs the priority-based divide and search autonomous transport vehicle path planning process PBDS described herein, to plan the route legs B, C, D (e.g., a time the route legs are executed relative to other route legs).

With the route legs B, C, D planned (i.e., planned route legs PRL), the time optimal paths and trajectories of these three route legs B, C, D are fixed, and the resolver 120PR proceeds to collect or otherwise obtain route legs for a second batch BRL2 of the sequence BRLS of batches BRL1-BRLn. As there are five route legs E, F, G, H, I that remain unplanned (i.e., unplanned route legs URL), and given the predetermined maximum number N of route legs in a batch BRL is set to three, the resolver 120PR expects to pick three of the route legs E, F, G, H, I for inclusion in, so as to form, the second batch BRL2 of route legs. As there is no route leg in the second batch BRL2 in the beginning, the resolver 120PR chooses the most urgent route leg (e.g., after updating the deferral penalties based on planning of route legs B, C, D, the route leg with the largest deferral penalty) of the route legs E, F, G, H, I as the first route leg to be assigned to batch BRL2. In the example illustrated in FIG. 6A, the most urgent route leg of the route legs E, F, G, H, I is route leg G, which is the longest route leg and is more likely to cause starvation under the assumption of all route legs having the same need by times. Here, the resolver 120PR determines route leg G is in the current batch BRL2, and that route leg G may sweep by route leg I's source pose and thus, route leg I is assigned into the current batch BRL2 as well.

With respect to delaying of route legs, the resolver 120PR determines that the arrival time of an autonomous guided bot of route leg H to its destination is affected by the route leg G more than it is affected by route legs E or F. Here, the resolver 120PR determines that, based on preventing delay, route leg H is assigned to the current batch BRL2 such that the three route legs of the second batch BRL2 are route legs G, H, I. The resolver 120PR employs the priority-based divide and search autonomous transport vehicle path planning process PBDS described herein, to plan the route legs G, H, I (e.g., a time the route legs are executed relative to other route legs).

With the trajectories and paths of route legs G, H, I planned (e.g., planned route legs PRL) the remaining unplanned route legs URL are route legs E, F. The resolver 120PR groups route legs E, F into a third batch BRL3 of route legs and employs the priority-based divide and search autonomous transport vehicle path planning process PBDS described herein, to plan the route legs E, F (e.g., a time the route legs are executed relative to other route legs).

Referring to FIGS. 1, 6B, 7, and 8, a threat graph (see FIG. 7) may be provided or otherwise constructed (FIG. 9, Block 900) to facilitate threat determination. Here, a route leg X is considered a threat to route leg Y if a planning of route leg X blocks a planning of route leg Y. The threat relations between a pair of route legs can be one, as noted above, a safety threat, a reachability threat, a delay threat, no threat at all, or a dummy same-bot threat. The hierarchy of the threats from highest threat to lowest threat is the safety threat/dummy-same-bot threat, reachability threat, delay threat, and no threat.

A safety threat is defined where route let X is planned, route leg Y may not be able to safely stay (e.g., route leg X is a safety threat to route leg Y). The definition of safely staying is that route leg X's reachable region intersects with Y's source region. As an example, where route leg X visits route leg Y's current aisle/pier (see route legs a, B in FIGS. 6A and 6B, where route leg a visits route leg B's current aisle/location), route leg X is considered a safety threat to route leg Y. As another example, route leg Y starts from the container transfer deck 130DC, and route leg X may visit route leg Y's source, route leg X is considered a safety threat to route leg Y.

With respect to a dummy-same-bot threat, a route leg is a dummy threat to its previous same-bot route leg, and we treat dummy threats as safety threats in analysis. This is because subsequent route legs can only be planned when previous route legs have been planned (e.g., planning subsequent legs first is impossible and this threats validity of planning previous legs).

A reachability threat is defined where route leg X is scheduled to idle at its source or destination forever, route leg Y may not be able to successfully reach its destination (see route legs B and C in FIGS. 6A, 6B where an autonomous guided bot 110 of route leg B blocks egress of an autonomous guided bot 110 of route leg C from exiting the pier). Here, route leg X is a reachability threat on route leg Y.

A delay threat is defined where two route legs' plans may collide, but one route leg can manage to go to its destination regardless of how the other route leg gets scheduled/planned. In this case, the two route legs are considered delay threats to each other. For example, two route legs come from different railways to two other different railways but they may collide on deck (e.g., see route legs G and H in FIG. 6A as described above).

No threat is defined where two route legs belong to different autonomous guided bots 110, 262 and their plans can never intersect with each other.

It is noted that in the priority-based divide and search autonomous transport vehicle path planning process PBDS described herein, intermediate destinations of an autonomous guided bot 110, 262 cannot be the autonomous guided bot's current aisle 130A/pier 130BW or route leg destination aisle 130A/pier 130BW and thus, autonomous guided bots 110, 262 will not push another autonomous guided bot 110, 262 out of an aisle 130A/pier 130BW due to demanding that occupied aisle 130A/pier 130BW as an intermediate destination. It is also noted that for an active route leg, the priority-based divide and search autonomous transport vehicle path planning process PBDS considers whether the active route leg is a safety threat to other route legs since the other route legs are treated as dynamic obstacles most of time.

Given the above, threat graphs as illustrated in FIG. 7 may be constructed and employed by the resolver 120PR where nodes of the threat graphs are route legs and edges are directed and each directed edge from node X to node Y represents that X is a threat to Y. When the threat graph is drawn/generated: solid arrows represent safety threats or dummy-same-bot threats; dashed arrows represent reachability threats; and the nodes in one dashed box have delay threats to each other. The threat graph illustrated in FIG. 7 represents the exemplary routes of FIGS. 6A and 6B.

The threat graph illustrated in FIG. 7 indicates the following: route leg a is a safety threat to route leg B since route leg a sweeps route leg B's source location; route leg A is a safety threat to route leg B since if route leg A is scheduled to move out the aisle, route leg B's source location might be swept by route leg A; route leg B is a reachability threat to route leg C since if route leg B arrives and stays there before route leg C leaves, route leg C cannot reach its destination; route leg F is a reachability threat to route leg E since if route leg F arrives and stays there before route leg E arrives, route leg E cannot reach its destination; route legs A, B, C, F, E are safety threats to route leg D since they all may sweep route leg D's source pose; route legs G and H are safety threats to route leg i since both may sweep by route leg i's source pose; route leg I is a reachability threat to both route legs G and H since route leg I can block both legs if route leg I is planned to idle; route leg G is a safety threat to route leg H since route leg G sweeps by route leg H's source pose; route leg H is a reachability threat to route leg G since if route leg H arrives at its destination earlier, route leg G can only stay; route legs A, B, C, D, E, F are delay threats to each other; route legs G, H, and I are also delay threats to each other; and any pair of route legs across the above delay-threatening group groups has no threat (i.e., route legs I, H, G are not threats to route legs A, B, C, D, E, F.

Referring to FIGS. 1 and 6B, calculation of reachable regions of a route leg, by the resolver 120PR is described, given the route leg source and destination. The reachable regions are employed by the resolver 120PR to determine threats between route legs.

An over-approximation reachable region of a route leg should include all the possible reachable regions of all the possible trajectories from the route leg source pose to its destination pose or all possible intermediate destinations. The route leg includes the following bounding regions: the route leg's possible reachable region on the transfer 130DC given all the possible trajectories; the route leg's possible reachable region on its source aisle 130A/pier 130BW given all the possible trajectories (optional for route legs from the transfer deck 130DC); the route leg's possible reachable region on its destination aisle 130A/pier 130BW given all the possible trajectories; and the route leg's possible reachable regions on the aisles 130A/piers 130BW of intermediate destinations.

The resolver 130PR may exclude the reachable region on intermediate destination railways is excluded because: it is not required for safety or reachability threat check—the intermediate destination cannot be on aisles/piers that are identical as some route leg source aisles/piers or route leg destination aisles/piers and thus it cannot impose a safety threat or reachability threat to any other route leg; and the transfer deck region is enough to indicate a delay threat—if two route legs can visit the same intermediate destinations (between the source and destination), and this makes them delay threats to each other, checking their deck reachable region is enough to find out this relation and checking the intermediate destination aisles/piers may be optional. Here, the resolver 120PR may be more efficient by excluding the reachable region on intermediate destination railways and only calculating the reachable regions on the transfer deck, source aisle/piers, and destination aisles/piers.

Referring to route leg E in FIG. 6B, the source, destination, and intermediate destination of route leg E illustrated. The reachable regions of route leg E on the container transfer deck 130DC, source pier 130BW, and destination aisle 130A are identified as the three bounded regions (i.e., reachable regions ES, ED, EE). Given the reachable regions ES, ED, EE, the resolver 120PR determines that route leg E may sweep route leg D's source pose and determines route leg E is a safety threat to route leg D.

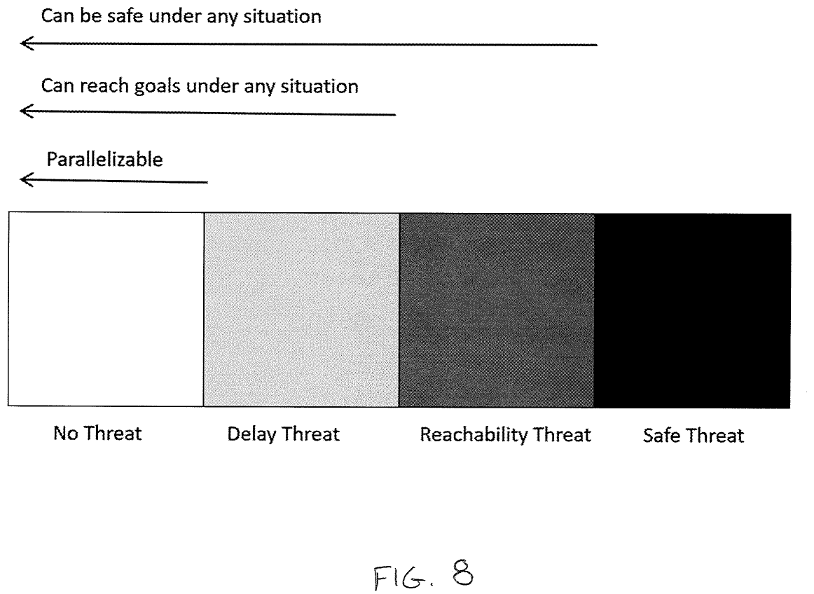

Referring also to FIG. 8, threat relation lemmas will be described.

Reachability Threat Lemma. If route leg X is at most a reachability threat (i.e., reachability threat, delay threat, no threat) to route leg Y, Y can always stay safe regardless of how X gets scheduled. For example, with reference to the threat graph of FIG. 7, route leg B is a reachability threat to route leg C, and regardless of how the autonomous guided bot 110 belonging to route leg B moves, route leg C is always safe.

Delay Threat Lemma. If route leg X is at most a delay threat (i.e., delay threat, no threat) to route leg Y, there always exists a feasible plan for route leg Y to reach its destination regardless of how route leg X gets scheduled. For example, again referring to FIGS. 6A, 6B, and 7, route legs C and E can only collide the container transfer deck 130DC, which can be avoided by delaying one of route legs C and E.

No Threat Lemma. If route leg X and route leg Y have not threat, they can be scheduled in parallel.

Transitivity Lemma. If there exists a path (i.e., a sequence of edges) from node X to node Y and there exists an edge with a threat type THREAT, we say route leg X a at least a THREAT to route leg Y.

Given a path from route leg X to route leg Y, the threat from route leg X to route leg Y given this path is determined by the least severe threat on this path. Here, if route leg A is a safety threat to route leg B, and route leg B is a delay threat to C, then route leg A is a delay threat to route leg C because route leg A may push route leg B to move but will never invalidate the reachability or safety of route leg C.

Given all the paths from route leg X to route leg Y, we know the threat from route leg X to route leg Y is the most severe threat among all the paths. Continuing the previous example route leg A is a delay threat to route leg C. If route leg A is a safety threat to route leg D and route leg D is a reachability threat to route leg C, route leg A is a reachability threat to route leg C since route leg A may push route leg D to move around and route leg D may block route leg C from reaching its destination.

With respect to the deferral penalty, the rules described herein (e.g., the route leg that is most impacted by being deferred into the next batch is included in the current batch) are employed by the resolver 120PR for selecting route legs to include in a batch BRL of route legs. The impact on a route leg due to deferring the route leg is captured or otherwise accounted for by the deferral penalty.

Recall that, the objective value of a priority based search is mainly determined by the following metrics: the number of failed legs NF; the number of unresolved conflicts N_{UC}; and all route leg durations D={dᵢ}ᵢ. Given all need times T, failed legs weight w₁, unresolvable conflicts weight w₂, the equation of computing the objective value is as follows:

$$F = {w}_{1} {N}_{F} + {w}_{2} {N}_{UC} + {F}_{D} ( D , T ) + {F}^{*} \qquad [ Eq . 1 ]$$

where, F* is a user-specified penalty on de-prioritizing certain route legs (e.g., charge legs, legs from deck), and F_{D} maps all the route leg duration D and need times T to a penalty F_{D}(D, T), which includes flow time and the penalty of missing need times:

$${F}_{D} ( D , T ) = {\sum }_{{d}_{i} ∈ D} {d}_{i} + {\sum }_{{t}_{j} ∈ T} {c}_{t} {max ( 0 , - {t}_{j} + {\sum }_{{d}_{k} ∈ D and {t}_{j} involves {d}_{k}} {d}_{k} )}^{2} \qquad [ Eq . 2 ]$$

Considering at each route leg's contribution to the above objective:
1. Failure and unresolvable collisions:
   a. if this route leg (“this route leg” as used in the present disclosures refers to the route leg currently being analyzed for inclusion in a batch of route legs) fails, it contributes w₁,
   b. if this route leg has nᵢ unresolvable collisions, it contributes w₂nᵢ;
2. if a route leg takes longer to complete, it also increases the duration penalty (i.e., flow time penalty and the need time penalty that involves this leg); and
3. user-specified penalty for de-prioritizing this route leg.

Whether the route leg fails may be dismissed or otherwise skipped as failure can only be true or false, and failure can be reflected in the number of unresolved conflicts. As such, if putting a route leg into the current batch has nᵢ unresolvable conflicts and duration dᵢ, and putting a route leg into the next batch has n′ᵢ unresolvable conflicts and duration d′ᵢ, its deferral penalty is defined as follows:

$$Δ = {w}_{2} ( {n}_{i}^{′} - {n}_{i} ) + ( {f}_{D} ( {d}_{i}^{′} ) - {f}_{D} ( {d}_{i} ) ) + {Δ}^{*} \qquad [ Eq . 3 ]$$

Where f_{D} is the duration penalty function with a scope on this leg. The duration penalty function being defined as follows:

$${f}_{D} ( {d}_{i} ) = {d}_{i} + {\sum }_{{t}_{j} ∈ T and {t}_{j} involves {d}_{i}} {c}_{t} {max ( 0 , - {t}_{j} + {\sum }_{{d}_{k} ∈ D and {t}_{j} involves {d}_{k}} {d}_{k} )}^{2} \qquad [ Eq . 4 ]$$

As seen above, the deferral penalty is determined by three metrics: the unresolvable collision number increase (n′ᵢ−nᵢ), which is related to the safety threat as described herein; two durations d′ᵢ and dᵢ under two conditions respectively, which are related to the reachability and delay threats as described herein; and user specified penalty Δ* for deferring certain route legs as described herein. Breaking deferral penalty ties will be discussed herein.

The resolver 120PR, when employing the priority-based divide and search autonomous transport vehicle path planning process PBDS, is configured to estimate the unresolvable collision number increase (n′ᵢ−nᵢ) using safety threats. Here, the resolver 120PR determines the unresolvable collision number increase (n′ᵢ−nᵢ) by checking how many legs in the current batch BRL safety-threaten a route leg that is to be selected. For example, a route leg B in the current batch BRL of route legs is considered to safety-threaten another route leg A if route leg B has a safety threat edge to route leg A in the threat graph, such as the threat graph illustrated in FIG. 7.

The resolver 120PR, when employing the priority-based divide and search autonomous transport vehicle path planning process PBDS, is also configured to estimate the two durations d′ᵢ and dᵢ. As described herein, two durations d′ᵢ and dᵢ estimated for determining the deferral penalty. At lest three methods may be employed by the resolver 120PR for estimating or otherwise calculating the two durations d′ᵢ and dᵢ. The three methods discussed below for calculating the two durations d′ᵢ and dᵢ are discussed in order of accuracy with the least accurate of the methods being discussed first.

The first method may be referred to as the Naïve method. To evaluate the impact of the reachability threat and the delay threat for a route leg naïvely, the resolver 120PR is configured to: compute the reference trajectory time of the route leg as dᵢ; and increase dᵢ to obtain d′ᵢ where d′ᵢ is equal to ᵢ(dᵢ+δ1+δ2). Here, δ1 equals 18n_{RT}:n_{RT} and is the number of route legs in the current batch of route legs having reachability threats to this route leg, where 18 is a user-specified parameter in seconds, which in other aspects may be larger or smaller than 18 seconds. δ2 equals 3n_{DT}:n_{DT} and is the number of route legs in the current batch of route legs having delay threats to this leg (excluding the route legs that already have a reachability threat to this route leg), where 3 is a user-specified parameter in seconds, which in other aspects may be larger or smaller than 3 seconds.

The second method increases the accuracy of the first method. For example, in the second method the route leg duration dᵢ is calculated by calling the priority-based divide and search autonomous transport vehicle path planning process PBDS (e.g., the single bot planner) to compute the end time based on all the previously planned route legs; however, d′ᵢ is determined in the same manner as noted above with respect to the first method (i.e., d′ᵢ is equal to ᵢ(dᵢ+δ1+δ2).

The third method for determining the two durations d′ᵢ and dᵢ includes systematically evaluating the effects of reachability threats and delay threats by using pairwise conflict resolution, temporal propagation, and a traffic map as described in U.S. provisional patent application No. 63/631,176 having attorney docket number 1127P017176-US (-#1) filed on Apr. 8, 2024 and titled “System and Method for Priority Based Management of Autonomous Vehicle Fleet,” the disclosure of which is incorporated herein by reference in its entirety.

The user specified penalty described above with respect to Equation 3 is what may be referred to as a large penalty (e.g., 100,000 seconds; in other aspects the penalty may be larger or smaller than 100,000 seconds) for route legs from the container transfer deck 130DC or charge route legs to facilitate prioritization of the route legs in an early (formed) batch of route legs. In other aspects, the number of route legs that may be active (e.g., so that an autonomous guided bot belonging to the route leg immediately proceeds to a destination) substantially immediately upon planning of the route legs are prioritized into a batch of route legs by weighting the deferral penalty of these route legs (e.g., with any suitable user-defined weight, such as a weight of 60) in the priority-based divide and search autonomous transport vehicle path planning process PBDS. Here, the weighting may be added to the deferral penalty of a route leg where: the route leg's trajectory start time given dᵢ is now; and the autonomous guided bot belonging to the route leg can reach its destination and perform its operation.

As described above, ties between autonomous guided bot routes when forming batches of route routes BRL may be broken, such as when a new or empty batch is being created. As can be seen in Equation 3, if there is no route leg in the current batch, all the items in the equation are zero except the user specified penalty Δ*. When Δ* is also zero, we may end up with 0 deferral penalty for every route leg (e.g., a tie exists between the route legs that are to be added to the current batch). To break the tie between the route legs one or more of the following tie breaks may be applied to break the tie.
Tie Break 1—where every route leg's deferral penalty is zero, the route legs whose delay is more likely to violate need time constraints (which is given by f_{D}(dᵢ)) is picked so as to break the tie; and
Tie Break 2—where Tie Break 1 results in zero penalty, which means all route legs are expected to meet deadlines, a slack time sum of the route legs duration is employed to lead to deadlines. For example, for each route leg duration dᵢ

$${\sum }_{{t}_{j} ∈ T and {t}_{j} involves {d}_{i}} ( {t}_{j} - {\sum }_{{d}_{k} ∈ D and {t}_{j} involves {d}_{k}} {d}_{k} ) \qquad [ Eq . 5 ]$$

As such, every time the route leg deferral penalty is updated by the resolver, the following values are returned: the deferral penalty (f_{D}(dᵢ)); the Tie Break 1 penalty; and in some aspects the Tie Break 2 penalty. To compare (e.g., two or more) the route legs for inclusion into the current batch, the penalty tuples are checked until the tie is broken.

In the present disclosure, the priority-based divide and search autonomous transport vehicle path planning process PBDS may one or more of: be configured to avoid blocking deferred legs; be configured to run anytime; be configured to adaptively configure batch size; be configured to only evaluate and batch an autonomous guided bot's 110, 262 first unplanned route leg; be configured to decouple safety threats; and be configured to plan route legs that are executed in parallel (e.g., parallelization).

To substantially prevent blocking of deferred legs, such as where there is a chance route leg A threats route leg B's reachability, but route leg A is selected into the current batch and route leg B is deferred to future batches. As an example of this threat, route leg A and route leg B go to the same location to perform pick or place, where route leg A is in the current batch and route leg B is deferred. Route leg A may be scheduled to reach its destination and idles there, thus route leg B cannot reach its destination. As another example of this threat, route leg A and route leg B start from the same aisle 130A or pier 130BW and route leg B's source location is deeper into the aisle or pier (i.e., further from the transfer deck 130DC) than route leg A's source location. Here, again, route leg A and route leg B are in different batches. Where route leg A is scheduled to idle at its current location, route leg B cannot leave aisle or pier. This threat may be resolved by placing route legs A and B in the same batch in future planning cycles; however, to substantially avoid blockage of deferred route legs the following method may be employed in the priority-based divide and search autonomous transport vehicle path planning process PBDS by the resolver 120PR. For a route leg, such as route leg A that threats the reachability of a deferred route leg B the priority-based divide and search autonomous transport vehicle path planning process PBDS collect three boxes (i.e., each box being a spatial boundaries that encompasses the bot's 110, 262 footprint at a given location on a bot travel surface within the automated storage and retrieval system 100) from route leg B's specifications. The three boxes are the box (i.e., source box) of the bot 110 belonging to route leg B at the source of route leg B, the box of the bot 110 at the bot's current aisle/pier entrance (this may be the same as the bot's source box if the source of route leg B is at an aisle/pier entrance), and the box (i.e., destination box) of the bot 110 belonging to route leg B at the destination of route leg B. These three boxes are added to route leg A's BoxesPreferredNotIdleAt so that in planning route leg A, the resolver 120PR does not let the bot of route leg A idle at those boxes of the bot of route leg B.

To configure the priority-based divide and search autonomous transport vehicle path planning process PBDS for anytime execution so as to plan route legs in large batches of route legs, the priority-based divide and search autonomous transport vehicle path planning process PBDS is provided with a runtime limit T. Here, the priority-based divide and search autonomous transport vehicle path planning process PBDS when executed by the resolver 120PR returns currently planned trajectories and paths of route legs in the current batch (even where all route legs of the current batch are not yet planned) when the runtime limit T is met/expires, noting that the trajectories in previously planned batches will not lead to collisions to any unplanned route legs because the previously planned batches are safety-threat-free. Given the runtime limit T, the overall anytime logic, when executed by the resolver 120PR, is as follows: plan the first batch (noting all the route legs that are safety-threatened by active route legs are collision-free), and keep planning batch by batch where when planning the batches and the runtime exceeds the runtime limit T the trajectories of the route legs in the planned batches are output.

If a first (or current) batch is too large, one or more of the methods below may be employed to avoid long planning times:

In a first method, a small (e.g., mini) batch size may be specified, such as by the resolver 120PR or in any other manner, such as by a user) for the first (or current) batch, or only route legs that are safety threatened by active route legs are planned. The mini first (or current) batch is planned by the resolver 120PR in a separate thread and the solution of planned route legs is output by the resolver 120PR if the planning times out (exceeds the runtime limit T) and the full first (or current) batch has not been planned.

In the second method, with planning each batch (including the first batch), an incumbent solution is recorded by the resolver 120PR (or other resolver noted herein) in any suitable memory (such as memory 120M or other memory noted herein) before all the route legs are planned and conflicts are resolved. The route legs in a batch can be further divided into small clusters that exactly cover the full batch. In each cluster, the route legs may have safety threats to each other recursively. For two route legs from different clusters, the route legs in the different clusters do not have safety threats to each other. The trajectories of the route legs are included in a cluster, where: all the route legs in this cluster are planned, the route legs in the cluster have no conflicts to resolve with other route legs in the same cluster, and the route legs in the cluster have no conflicts to resolve with already included clusters' route legs' plans. Here, route leg plans may be extracted from partially planned batches of route legs.

As noted above, the priority-based divide and search autonomous transport vehicle path planning process PBDS may be configured to adaptively configure the batch size of the route leg batches BRL. As may be realized, choosing a proper batch size for the priority-based divide and search autonomous transport vehicle path planning process PBDS may balance its runtime and performance. While, a large batch size limit can lead to good solution quality planning of route legs in the large batch may take long time. With smaller batch size limits, the priority-based divide and search autonomous transport vehicle path planning process PBDS can plan all route legs very fast but the solution may be of lower quality.

As may be realized, a selected batch size limit may be employed on different traffic maps, each map having a different number of autonomous guided bots 110, 262. To simplify the the priority-based divide and search autonomous transport vehicle path planning process PBDS the batch size limit may be selected so that the batch size limit may be applied to the different traffic maps without creating multiple router builds.

To adaptively select the batch size limit the resolver 120PR (or other resolver described herein) may maintain an empirically derived dictionary DIC that maps (i.e., Map Name, Bot Number) to a batch size. For example, non-limiting examples of maps may include: (NBF, 30)=>100; (NBF, 40)=>50; and (NBF, 50)=>30. Here, where there are 35 bots on the NBF map, the resolver 120PR selects a batch size limit of 50 route legs.

Given a current map size, bot number, route leg number, and an estimation of how many conflicts to resolve, the resolver 120PR (or other resolver described herein) may be configured to predict the total time to plan and adaptively stop collecting route legs into the current batch. Here, the resolver 120PR is configured in any suitable manner to predict the runtime T given the factors mentioned above.

The resolver 120PR (or any other resolver described herein) may be configured to employ a naïve approach for adaptively selecting the batch size limit. Here, the batch size limit is selected on-the-fly. For example, the user inputs into the resolver 120PR (through any suitable user interface) an initial batch size N (this initial batch size is to be a small number (e.g., about 30 or less than 30), a batch size change step n, and an expected runtime T. With these three parameters N, n, T input to the resolver 120PR, the resolver executes the priority-based divide and search autonomous transport vehicle path planning process PBDS so as to set the batch size limit to N initially and collect the runtime time of each planning cycle in the past period (e.g., the period being about 5 minutes, although in other aspects the period may be larger or smaller than about 5 minutes). Here, if the average runtime time is smaller than T, the batch size limit is increased by the batch size change step n. If the average runtime time is larger than T, the batch size limit is decreased by the batch size change step n. If planning times out, the batch size limit is reset to the initial batch size N value. This adaptive selective of the batch size limit may also be adaptive to processing power of the resolver, where be applicable to an increased number of the batch size may be decreased in instances of limited processing ability and in other instances, such as where the resolver 120PR is planning fewer tasks, the batch size may be increased.

As noted above, the resolver 120PR, configured with the priority-based divide and search autonomous transport vehicle path planning process PBDS, is configured to evaluate and batch only the first unplanned leg(s) of the bot(s). As described herein, in the priority-based divide and search autonomous transport vehicle path planning process PBDS any route leg with the largest deferral penalty is chosen even if it is not the first unplanned route leg of the autonomous guided bot 110, 262. If the selected route leg is not the first unplanned route leg of the autonomous guided bot 110, 262, the previous same-bot unplanned legs of the selected route leg are selected via dummy same-bot threats. However, evaluation of all route legs may be avoided as the first unplanned legs are may be prioritized (e.g., relative to subsequent route legs) to pick and plan first. Also, where the second or third unplanned legs of the autonomous guided bot 110, 262 are selected for planning, the previous legs of the second or third unplanned legs must be selected as well even though they might not be that important to pick. Here, to avoid selection of subsequent route legs, reduce computational times, and increase storage and retrieval system throughput, only the first unplanned route legs of each bot are selected.

As also noted above, safety threats may be decoupled from the route leg planning process. As described herein, the priority-based divide and search autonomous transport vehicle path planning process PBDS may output batches BRL that exceed the batch size limit (e.g., the batch includes a number of route legs that exceeds the predetermined maximum number of route legs specified for a batch) when too many route legs are safety-threatened by one route leg. Decoupling safety threats from route leg planning may be employed with very small batches (e.g., each batch having a very small number route legs of about 5 route legs or less) where the existence of safety threats may be high and the batch size limit is not to be exceeded (although in other aspects decoupling safety threats may be employed with batches having a batch size limit greater than about route legs). Here, the priority-based divide and search autonomous transport vehicle path planning process PBDS is modified such that with batching of route legs, the resolver 120PR (or other resolver described herein) does not force selection of route legs that are safety-threatened by the route legs in the current batch. Here, the resolver 120PR (configured with the priority-based divide and search autonomous transport vehicle path planning process PBDS), when planning a route leg (such as route leg A), which is in the current batch that threats the safety of a deferred route leg (such as route leg B), reserves route leg B's source box (as described herein) for route leg A and thus route leg A cannot be unsafe to route leg B anymore. It is noted that, safety threats may not be decoupled from active route legs.

With respect to parallelization, it is noted that the overall strategy of the priority-based divide and search autonomous transport vehicle path planning process PBDS with parallelization (e.g., PBDPS) is to plan all the route legs in a sequence BRLS of batches BRL. Here, the user-defined parameters of the maximum size of a batch to plan (e.g., maximum batch size Nm) and (optionally) the runtime limit T are employed. The resolver 120PR (or other resolver described herein) determines if the threat graphs (see FIG. 7) of the route legs to be planned are disconnected. Where the threat graphs are disconnected, the resolver 120PR launches separate threads to perform the priority-based divide and search autonomous transport vehicle path planning process PBDS for each disconnected part of the threat graphs, and the solutions obtained for each of the separate threats by the priority-based divide and search autonomous transport vehicle path planning process PBDS are returned as a combined solution. The resolver 120PR initializes non-active route legs' deferral penalties.

All route legs whose safety is threatened by active route legs are collected/obtained by the resolver 120PR. Given the collected safety-threatened route legs, the resolver 120PR initializes a set of batches BRLS where each batch BRL1-BRLn contains a set of route legs that at least delay-threaten each other, and route legs across different batches BRL1-BRLn do not threaten each other.

The following are then repeated by the resolver 120PR, for each of the batches BRL1-BRLn in the sequence BRLS (where the batches are analyzed in parallel with each other), until all route legs have been planned or runtime limit has been exhausted, where the solution is returned when the process is terminated. Determine if threat graphs of the batch are disconnected, and where disconnection exists, launch separate threads to perform priority-based divide and search autonomous transport vehicle path planning process PBDS for each disconnected part, where the resolver 120PR collects the returned solutions from those threads and returns the combined solution. As an option, the resolver 120PR determines if the runtime has exceeded the runtime limit T, where if the runtime limit T is exceeded the priority-based divide and search autonomous transport vehicle path planning process PBDS process is stopped and a solution is returned (as described herein with respect to the application of the runtime limit T). The resolver 120PR determines if the number of unplanned route legs is not larger (i.e., is smaller) than the maximum number of route legs in a batch BRL (i.e., the maximum batch size Nm). Where the number of unplanned route legs is smaller than the maximum number of route legs in a batch BRL, all legs are planned and the priority-based divide and search autonomous transport vehicle path planning process PBDS ends. Where the number of unplanned route legs is larger than the maximum batch size Nm, the resolver updates the route leg deferral penalty given the newly added route legs into the batch. The batches BRL are updated where: the unplanned route leg(s) with the highest deferral penalty are added into the corresponding batch; all route legs that are a safety threat to newly added legs are recursively added into the corresponding batch; and batches that are (at least delay) threated by newly added legs are merged. A batch BRL is planned by the priority-based divide and search autonomous transport vehicle path planning process PBDS if this batch's size is not less than the maximum batch size Nm.

Referring to FIGS. 1, 6A, 6B, and 7 an example route leg planning will be described employing the priority-based divide and search autonomous transport vehicle path planning with parallelization process PBDPS. Here, the maximum batch size Nm is set to 3 route legs in each batch BRL. In the route leg example of FIGS. 6A and 6B, whose threat graph is illustrated in FIG. 7, it is determined by the resolver 120PR (or other resolver described herein) that the threat graph is disconnected and has two parts 710, 711. Here, separate threads (one thread for route legs A, B, C, D, E, F and another thread for route legs I, G, H) are launched by the resolver 120PR for each part 710, 711. Planning results are collected from the two threads where the computation of the two threads is effected in parallel by the resolver 120PR is described below.

For part 710 of the threat graph it is determined by the resolver 120PR that there are no disconnected parts to plan in parallel. Non-active route legs' deferral penalty is initialized and sorted to obtain the following order (i.e., route leg, deferral penalty):
B, 20
C, 18
E, 12
F, 8
D, 5
A, 0

The route legs B and D whose safety is threatened by active route leg a are collected. As route legs B and D are threats to each other, only one batch is generated that includes route legs B and D.

In a first iteration for batch {(B, D)} there are no disconnected parts of the threat graph for batch {(B, D)} to plan in parallel. The number of unplanned route legs is 6, which is greater than the maximum number of route legs 3. Given newly added route legs B, D, route leg C might be blocked and as such, the deferral penalty of route leg C is increased. Route leg C's current deferral penalty is 18. A placeholder method is employed in this method by simply doubling this penalty, so that the deferral penalty of route leg C is increased to 36. Route leg C is added to the batch with route legs B and D so form batch {(B, D, C)}. There is no need to update the batches and batch {(B, D, C)} is planned.

In a second iteration for batch {(A, F, E)} the number of unplanned legs is less than the maximum number of route legs in a batch, the all of the route legs are planned, and the thread terminates. The planning of batch {(I, G, H)} may be similar to that of batch {(A, F, E)}.

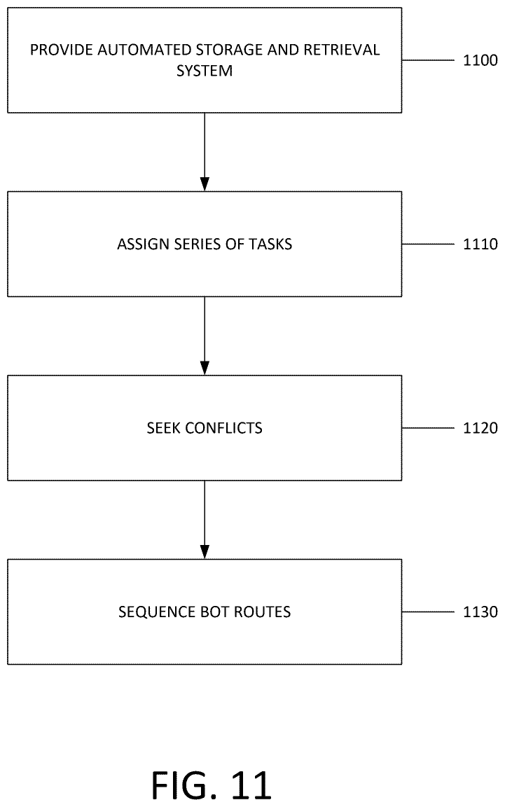

Referring to FIGS. 1-8 and 11, a method includes providing an automated storage and retrieval system 100 (FIG. 11, Block 1100) that has: a storage array SA with storage locations 130S arrayed along aisles 130A and a static (i.e., non-moving) non-deterministic deck 130DC communicating with each aisle 130A; a plurality of autonomous guided bots 110, each configured for free ranging motion so as to traverse freely along bot paths (e.g., BPT-BPT3, see FIGS. 4 and 5B, as described herein), including optimal paths, on the non-deterministic deck 130DC so that each autonomous guided bot 110 accesses each storage location 130S in each aisle 130A from each location on the non-deterministic deck 130DC and aisles 130A; and a controller 120, 2500 communicably connected to each autonomous guided bot 110 of the plurality of autonomous guided bots 110. The method also includes assigning, with the controller 120, 2500, a series of tasks (FIG. 11, Block 1110) to each autonomous guided bot 110, which series of tasks includes at least one task to at least one autonomous guided bot 110 moving the autonomous guided bot 110 from initial location to a different final location via bot routes 499A-499C (see FIGS. 4, 6A and 6B). The method includes seeking, with a resolver 120PR, 2500PR of a bout route planner 120P, 2500P of the controller 120, 2500, conflicts (FIG. 11, Block 1120) between autonomous guided bots 110, effecting the series of tasks, on the bot routes 499A-499C describing bot paths (see FIGS. 4, 6A, and 6B), and resolving each bot route 499A-499C so as to determine the bot route, at least one bot route 499A-499C being determined based on bot priority. The method includes sequencing, with the resolver 120PR, 2500PR, the bot routes 499A-499C (FIG. 11, Block 1130) into a sequence of bot route leg batches BRL, wherein route legs (as described herein, and illustrated in the Figures as Manhattan distances, which is a metric in which the distance between two points is the sum of the absolute differences in their Cartesian coordinates), forming each bot route in entirety, are divided into corresponding batch of the sequence of route leg batches BRL.

In accordance with the present disclosure the method includes one or more of, individually, in any combination with each other, and/or in any combination with the features described above: each bot route 499A-499C is determined batch by batch; the series of tasks include a current task, and at least one of a preceding task and a following task; the at least one task is the current, preceding or following task; the bot route leg batches BRL are prioritized in sequence BRLS, and an earlier or preceding batch in the sequence has a higher priority to a later or subsequent batch in the sequence; at least one bot route leg, in the sequence of bot route legs BRLS describing a bot route 499A-499C, is deferred to a later bot route leg batch BRL in the sequence of bot route leg batches BRLS; the later bot route leg batch, that includes the deferred at least one bot route leg, is disposed in a later place in the sequence BRLS of bot route leg batches BRL than the at least one bot route leg in sequence of the bot route legs describing the bot route 499A-499C; the deferred at least one bot route leg has a lower priority than undeferred bot route legs; the optimal paths are time optimal paths; the optimal paths are unparameterized paths; and the time optimal paths are time optimal unparameterized paths.

The following are provided in accordance with the present disclosure and may be employed individually, in any combination with each other, and/or in any combination with the features described above.

In accordance with the present disclosure an automated storage and retrieval system comprises: a storage array with storage locations arrayed along aisles and a non-deterministic deck communicating with each aisle; a plurality of autonomous guided bots, each configured for free ranging motion so as to traverse freely along bot paths, including optimal paths, on the non-deterministic deck so that each autonomous guided bot accesses each storage location in each aisle from each location on the non-deterministic deck and aisles; and a controller communicably connected to each autonomous guided bot of the plurality of autonomous guided bots so as to assign a series of tasks to each autonomous guided bot, which series of tasks includes at least one task to at least one autonomous guided bot moving the autonomous guided bot from initial location to a different final location via bot routes; wherein the controller is configured with a bot route planner that has a resolver that seeks conflicts between autonomous guided bots, effecting the series of tasks, on the bot routes describing bot paths, and resolves each bot route so as to determine the bot route, at least one bot route being determined based on bot priority, and wherein the resolver is arranged to sequence the bot routes into a sequence of bot route leg batches, wherein route legs, forming each bot route in entirety, are divided into corresponding batch of the sequence of route leg batches.

In accordance with the present disclosure the automated storage and retrieval system includes one or more of, individually, in any combination with each other, and/or in any combination with the features described above: each bot route is determined batch by batch; the series of tasks include a current task, and at least one of a preceding task and a following task; the at least one task is the current, preceding or following task; the bot route leg batches are prioritized in sequence, and an earlier or preceding batch in the sequence has a higher priority to a later or subsequent batch in the sequence; at least one bot route leg, in the sequence of bot route legs describing a bot route, is deferred to a later bot route leg batch in the sequence of bot route leg batches; the later bot route leg batch, that includes the deferred at least one bot route leg, is disposed in a later place in the sequence of bot route leg batches than the at least one bot route leg in sequence of the bot route legs describing the bot route; the deferred at least one bot route leg has a lower priority than undeferred bot route legs; the optimal paths are time optimal paths; the optimal paths are unparameterized paths; and the time optimal paths are time optimal unparameterized paths.

In accordance with the present disclosure a method includes providing an automated storage and retrieval system comprising: a storage array with storage locations arrayed along aisles and a non-deterministic deck communicating with each aisle; a plurality of autonomous guided bots, each configured for free ranging motion so as to traverse freely along bot paths, including optimal paths, on the non-deterministic deck so that each autonomous guided bot accesses each storage location in each aisle from each location on the non-deterministic deck and aisles; and a controller communicably connected to each autonomous guided bot of the plurality of autonomous guided bots. The method also includes assigning, with the controller, a series of tasks to each autonomous guided bot, which series of tasks includes at least one task to at least one autonomous guided bot moving the autonomous guided bot from initial location to a different final location via bot routes; seeking, with a resolver of a bout route planner of the controller, conflicts between autonomous guided bots, effecting the series of tasks, on the bot routes describing bot paths, and resolving each bot route so as to determine the bot route, at least one bot route being determined based on bot priority; and sequencing, with the resolver, the bot routes into a sequence of bot route leg batches, wherein route legs, forming each bot route in entirety, are divided into corresponding batch of the sequence of route leg batches.

In accordance with the present disclosure the method includes one or more of, individually, in any combination with each other, and/or in any combination with the features described above: each bot route is determined batch by batch; the series of tasks include a current task, and at least one of a preceding task and a following task; the at least one task is the current, preceding or following task; the bot route leg batches are prioritized in sequence, and an earlier or preceding batch in the sequence has a higher priority to a later or subsequent batch in the sequence; at least one bot route leg, in the sequence of bot route legs describing a bot route, is deferred to a later bot route leg batch in the sequence of bot route leg batches; the later bot route leg batch, that includes the deferred at least one bot route leg, is disposed in a later place in the sequence of bot route leg batches than the at least one bot route leg in sequence of the bot route legs describing the bot route; the deferred at least one bot route leg has a lower priority than undeferred bot route legs; the optimal paths are time optimal paths; the optimal paths are unparameterized paths; and the time optimal paths are time optimal unparameterized paths.

It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the present disclosure.

1. An automated storage and retrieval system comprising:
a storage array with storage locations arrayed along aisles and a non-deterministic deck communicating with each aisle;
a plurality of autonomous guided bots, each configured for free ranging motion so as to traverse freely along bot paths, including optimal paths, on the non-deterministic deck so that each autonomous guided bot accesses each storage location in each aisle from each location on the non-deterministic deck and aisles; and
a controller communicably connected to each autonomous guided bot of the plurality of autonomous guided bots so as to assign a series of tasks to each autonomous guided bot, which series of tasks includes at least one task to at least one autonomous guided bot moving the autonomous guided bot from initial location to a different final location via bot routes;
wherein the controller is configured with a bot route planner that has a resolver that seeks conflicts between autonomous guided bots, effecting the series of tasks, on the bot routes describing bot paths, and resolves each bot route so as to determine the bot route, at least one bot route being determined based on bot priority, and
wherein the resolver is arranged to sequence the bot routes into a sequence of bot route leg batches, wherein route legs, forming each bot route in entirety, are divided into corresponding batch of the sequence of route leg batches.

2. The automated storage and retrieval system of claim 1, wherein each bot route is determined batch by batch.

3. The automated storage and retrieval system of claim 1, wherein the series of tasks include a current task, and at least one of a preceding task and a following task.

4. The automated storage and retrieval system of claim 3, wherein the at least one task is the current, preceding or following task.

5. The automated storage and retrieval system of claim 1, wherein the bot route leg batches are prioritized in sequence, and an earlier or preceding batch in the sequence has a higher priority to a later or subsequent batch in the sequence.

6. The automated storage and retrieval system of claim 1, wherein at least one bot route leg, in the sequence of bot route legs describing a bot route, is deferred to a later bot route leg batch in the sequence of bot route leg batches.

7. The automated storage and retrieval system of claim 6, wherein the later bot route leg batch, that includes the deferred at least one bot route leg, is disposed in a later place in the sequence of bot route leg batches than the at least one bot route leg in sequence of the bot route legs describing the bot route.

8. The automated storage and retrieval system of claim 6, wherein the deferred at least one bot route leg has a lower priority than undeferred bot route legs.

9. The automated storage and retrieval system of claim 1, wherein the optimal paths are time optimal paths.

10. The automated storage and retrieval system of claim 1, wherein the optimal paths are time unparameterized paths.

11. A method comprising:
providing an automated storage and retrieval system comprising:
a storage array with storage locations arrayed along aisles and a non-deterministic deck communicating with each aisle;
a plurality of autonomous guided bots, each configured for free ranging motion so as to traverse freely along bot paths, including optimal paths, on the non-deterministic deck so that each autonomous guided bot accesses each storage location in each aisle from each location on the non-deterministic deck and aisles; and
a controller communicably connected to each autonomous guided bot of the plurality of autonomous guided bots;
assigning, with the controller, a series of tasks to each autonomous guided bot, which series of tasks includes at least one task to at least one autonomous guided bot moving the autonomous guided bot from initial location to a different final location via bot routes;
seeking, with a resolver of a bout route planner of the controller, conflicts between autonomous guided bots, effecting the series of tasks, on the bot routes describing bot paths, and resolving each bot route so as to determine the bot route, at least one bot route being determined based on bot priority; and
sequencing, with the resolver, the bot routes into a sequence of bot route leg batches, wherein route legs, forming each bot route in entirety, are divided into corresponding batch of the sequence of route leg batches.

12. The method of claim 11, wherein each bot route is determined batch by batch.

13. The method of claim 11, wherein the series of tasks include a current task, and at least one of a preceding task and a following task.

14. The method of claim 13, wherein the at least one task is the current, preceding or following task.

15. The method of claim 11, wherein the bot route leg batches are prioritized in sequence, and an earlier or preceding batch in the sequence has a higher priority to a later or subsequent batch in the sequence.

16. The method of claim 11, wherein at least one bot route leg, in the sequence of bot route legs describing a bot route, is deferred to a later bot route leg batch in the sequence of bot route leg batches.

17. The method of claim 16, wherein the later bot route leg batch, that includes the deferred at least one bot route leg, is disposed in a later place in the sequence of bot route leg batches than the at least one bot route leg in sequence of the bot route legs describing the bot route.

18. The method of claim 16, wherein the deferred at least one bot route leg has a lower priority than undeferred bot route legs.

19. The method of claim 11, wherein the optimal paths are time optimal paths.

20. The method of claim 11, wherein the optimal paths are time unparameterized paths.
